(19) United States
(12) Patent Application Publication
(10) Pub. No.: US 2005/0216380 A1
(43) Pub. Date: Sep. 29, 2005

(54) Data warehouse for management and analysis of telecommunications access services

(76) Inventors: Mary B. Morris, Birmingham, AL (US); Mark G. Torres, Birmingham, AL (US); Ronald C. Ebright, Alpharetta, GA (US); Lori W. Bass, Birmingham, AL (US)

Correspondence Address: Bambi Faivre Walters, P.O. Box 5743, Williamsburg, VA, 23188, US

(21) Appl. No.: 10/652,292

(22) Filed: Aug. 30, 2003

(51) Int. Cl. G06F 17/60

(52) U.S. Cl. 705/34

(57) ABSTRACT

This invention provides methods and systems for accessing, compiling, and processing rate and billing information from multiple billing systems, service regions, and/or regional rate guides to create an Access Customer Analysis Database (ACAD) of merged rate and billing records of data associated with a customer, a service agreement, a service usage, a service rate, service availability, a type of service, and/or a service region.

### CROSS REFERENCE TO RELATED APPLICATIONS

This application relates to patent application entitled “Systems and Methods for Management and Analysis of Telecommunications Access Services” by Mark G. Torres, Mary B. Morris, Lori W. Bass, and Donn P. Sundby, (Attorney Docket No. 03-BS011 (BS02259)) filed concurrently herewith, and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention relates generally to the field of analysis, marketing, billing, and/or management of access carrier services customer accounts, and in particular, to an architecture and method for deriving billing information from multiple billing systems and service regions, for presenting consolidated views of telecommunications access service detail that may include network configuration and availability, a customer rate element, commitment and usage, and for creating and monitoring access carrier service terms and conditions based on information provided in the consolidated views.

2. Description of the Related Art

Before 1984, the Bell telephone system consisted of 22 local Bell telephone companies that were owned by American Telephone and Telegraph (AT&T). AT&T and the local Bell companies sold local, domestic U.S., and international long distance services, as well as customer premises telephone hardware. Customers had one point of contact for all of their telecommunications requirements and AT&T effectively held a monopoly on all telephone services. To meet the accounting needs of this monopoly during this period, AT&T developed billing information technologies and applications that tracked telephone service usage and billing records. These early software and database technologies were relatively primitive and did not allow for the complete integration of billing information across different types of customer accounts, customer operating units (e.g., consumer or small business), and geographic locations (e.g., regional accounting offices, states, and/or or LATAs). Today, these early billing technologies are referred to as legacy technologies.

In 1984, the United States government ordered the divestiture of AT&T, requiring AT&T to transfer ownership of the 22 local phone companies to seven Regional Bell Operating Companies (RBOCs). The seven RBOCs retained the “Bell” logo and the right to sell local and toll calling within local areas. Further, the RBOCs continued to use the legacy technologies to administer customer accounts and track billing activities within their individual regions. During this period, because minimal competition existed within the regions of the RBOCs, the RBOCs held monopolies within their individual regions, giving them little incentive to pursue customers by analyzing customer value across the region and developing targeted marketing programs. Essentially, RBOCs had guaranteed customers who would use the RBOC regardless of discounting or other promotional programs.

However, in 1996, the United States Congress enacted the Telecommunications Act of 1996, opening the Bell territories to competition from long distance vendors, cable companies, local access providers, utility companies, and other RBOCs. As a result, telecommunications service providers (collectively referred to herein as “telcos”) could compete in each other's markets and develop and market new products and services for a wider customer base. Thus, for the first time, RBOCs found it necessary to understand and analyze customer accounts and billing activity within the different RBOC regions and the different legacy systems. Armed with this information, RBOCs could develop customer-specific and/or rate element specific discount programs and promotions based on the revenue derived from that particular customer or rate element. With increased competition, the RBOCs needed to analyze customer value and offer discount programs that encouraged customer retention while maximizing RBOC profit.

To analyze customer value within a service region, RBOCs must consolidate and decipher revenue information across the “artificial boundaries” in a RBOC region. These artificial boundaries are defined by the original legacy systems developed by AT&T. For example, customer operations units (COUs) established by the RBOC handle specific customer types and regional accounting offices (RAOs) within the RBOC region distribute the administrative and accounting functions of the RBOC. Frequently, each of these entities accesses and/or administers information on customers in separate databases. Thus, when a customer falls under more than one customer type and/or within more than one artificial boundary, that customer's rate element and billing information is scattered across several individual databases. Therefore, to completely understand a customer's value to the Telco within the overall region, the rate element and billing information must be consolidated, summarized, and analyzed.

Two principal legacy systems for consolidating, summarizing, and analyzing rate element and billing data are the Carrier Access Billing System (CABS) and the Local Exchange Routing Guide (LERG). CABS maintains billing records for wholesale customers who purchase large blocks of telephone capacity from the RBOCs, usually at rates discounted from retail prices. Typical wholesale customers include access carrier service providers, such as interexchange carriers (i.e., long distance companies), large corporate clients, and/or blocks of consumers seeking lower rates through high volume usage of the system as well as businesses that purchase telephone capacity for resale to individual consumers. LERG maintains current network configuration and scheduled changes to the network. LERG is based on the North American numbering plan and tracks number plan area (e.g., area code) and prefix assignments, also referred to as NPA/NXX assignments. The LERG data specifies the end office and/or tandem office and also specifies routing associated with the end office and/or tandem office. AT&T developed CABS and LERG legacy systems as independent applications, without means for integrating the information they contain. Thus, to understand a customer's potential value, telcos must consult these and several other billing systems to access, gather, and/or analyze the data to effectively service the customer.

### BRIEF SUMMARY OF THE INVENTION

This invention provides methods and systems for accessing, integrating, and analyzing CABS, LERG, and other rate and billing information to create an access customer analysis database that may be used to analyze an access carrier service customer rate and billing detail to effectively service customer accounts, resolve billing questions, and/or develop new revenue products. This invention summarizes information from multiple telephone rate and billing systems across multiple telephone service regions and provides a Telco with intelligent consolidated views of a customer's telephone usage, rate and billing details, service agreements, and/or service availability. By presenting billing activity, revenue totals, rates, and/or availability, the intelligently merged rate and billing records give the Telco a comprehensive understanding of a particular customer's value, enabling the Telco to better serve the customer and to formulate customer-specific rate and billing plan terms, conditions, and/or discounts.

According to an embodiment of this invention, a method for creating an access customer analysis database includes accessing rate and billing records of the customer from a carrier access billing system, accessing network configuration data from a local exchange routing guide, automatically compiling the regional rate record and/or the billing record to create one or more merged rate, rate element, network configuration and billing record, and processing the merged rate and billing record to create the access customer analysis database. The access customer analysis database may include merged rate, rate element, network configuration, network availability, and/or billing records associated with a customer, a service agreement, a service usage, a service rate, service availability, a type of service, and/or a service region. In further embodiments, the method includes one or more of the following: accessing the access customer analysis database, creating an access carrier service rate and billing detail based on the merged rate and billing record, reporting the access carrier service rate and billing detail of the customer, using the access carrier service rate and billing detail to manage an access carrier rate and billing plan, and/or presenting alternate promotional codes, rate plans and service agreements.

According to another embodiment of this invention, an access customer analysis database system includes a client system containing a client program, an application server containing an application server program, and a database server containing an access customer analysis database (ACAD). In response to a user request for a access carrier service rate and billing detail through the client system, the application server program retrieves selected information from the access customer analysis database, the application server program performs any required business logic, the application server program returns the information to the client program, and the client program may perform any required additional business logic to format and display the access carrier service rate and billing detail. The application server includes business applications and legacy applications. The business application is an access carrier service rate and billing details manager application and may also include other applications. The legacy applications include a carrier access billing system and a local exchange routing guide. The carrier access billing system maintains billing information; and, the local exchange routing guide contains network configuration detail. The information retrieved from the access customer analysis database may include billing records derived from the carrier access billing system, network detail derived from the local exchange routing guide, and one or more merged regional rate and billing records that are compiled from business logic contained in a data transformation application.

According to another embodiment, this invention provides a computer network architect that includes a carrier access billing system, a local exchange routing guide, and a data transformation application for building an access customer analysis database (ACAD). The system interfaces with the carrier access billing system and the local exchange routing guide, accesses a billing record of the customer from the carrier access billing system, accesses network configuration detail from the local exchange routing guide, uses business rules to transform and/or evaluate the billing record with the network configuration record to create one or more merged rate and billing records, creates and maintains an access carrier analysis database of the merged rate and billing record, interfaces with an access carrier service rate and billing details management application, and supports online tasks and offline data maintenance and exchange.

Thus, this invention supplants the time consuming process of the prior art by quickly compiling customer rate and revenue data from multiple systems and regions, and interfacing with access carrier service rate and billing details management application in order to present the merged data in consolidated, selected views of access carrier service rate and billing details and/or to present alternate customer-specific promotional rate and billing products. In addition, this invention provides means for executing selected reports and means for updating and/or correcting merged data.

Other systems, methods, and/or computer program products according to embodiments will be or become apparent to one with skill in the art upon review of the following figures and detailed description. It is intended that all such additional systems, methods, and/or computer program products be included within this description, be within the scope of this invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, in which:

FIG. 1 is a block diagram showing an Access Customer Analysis Database (ACAD) Online Interface module that resides in a computer system according to an embodiment of this invention;

FIG. 2A is a schematic diagram of a three-tier carrier access rate and billing computer network architect according to an embodiment of this invention;

FIG. 2B is a schematic diagram of a two-tier carrier access rate and billing computer network architect according to an embodiment of this invention;

FIG. 3 is a schematic illustrating an overview of an exemplary operating environment of an ACAD Online 316 system according to an embodiment of this invention;

FIG. 4 is a schematic illustrating a logical view of ACAD Online 316 products/plans, other reports, ad-hoc queries, and administration according to an embodiment of this invention;

FIGS. 5-31 are pictures of ACAD Online 316 Graphical User Interfaces (GUIs) according to one or more embodiments of this invention; and

FIG. 32 illustrates an overview of the ACAD-C Data Model according to an embodiment of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the schematics and the like represent conceptual views of illustrative structures embodying this invention.

In the claims hereof any element expressed as a means for performing a specified function is intended to encompass any way of performing that function including, for example, a combination of elements that performs that function. The invention as defined by such claims resides in the fact that the functionalities provided by the various recited means are combined and brought together in the manner that the claims call for. Applicant thus regards any means that can provide those functionalities as equivalent as those shown herein.

This invention provides methods and systems for creating access carrier service rate and billing details, developing promotional rate and billing products and plans, evaluating impacts of existing and proposed promotional products and plans, and updating information associated with the access carrier service rate and billing details. Related methods and systems for accessing, associating, and compiling rate and billing information from multiple billing systems, service regions, and/or regional rate guides are addressed in a concurrently filed patent application entitled “Systems and Methods for Management and Analysis of Telecommunications Access Services” by Mark G. Torres, Mary B. Morris, Lori W. Bass, and Donn P. Sundby, (Attorney Docket No. 03-BS011 (BS02259)) filed concurrently herewith, which is hereby incorporated by reference.

As used herein, the term “client workstation” includes wired and wireless communications devices, such as a mobile phone, a wireless phone, a Wireless Access Protocol (WAP) phone, a satellite phone, a personal computer (PC), a modem, a pager, a digital music device, a digital recording device, a personal digital assistant (PDA), an interactive television, a digital signal processor, and/or a Global Positioning System device. Further, as used herein, the term “data” includes electronic information, such as, for example facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, and/or (4) profiles associated with configuration, authenticity, security, and others. In various embodiments, the data may be stored by the client workstation, a peripheral storage device coupled with the client workstation, a network connected with the client workstation, and/or other connected networks.

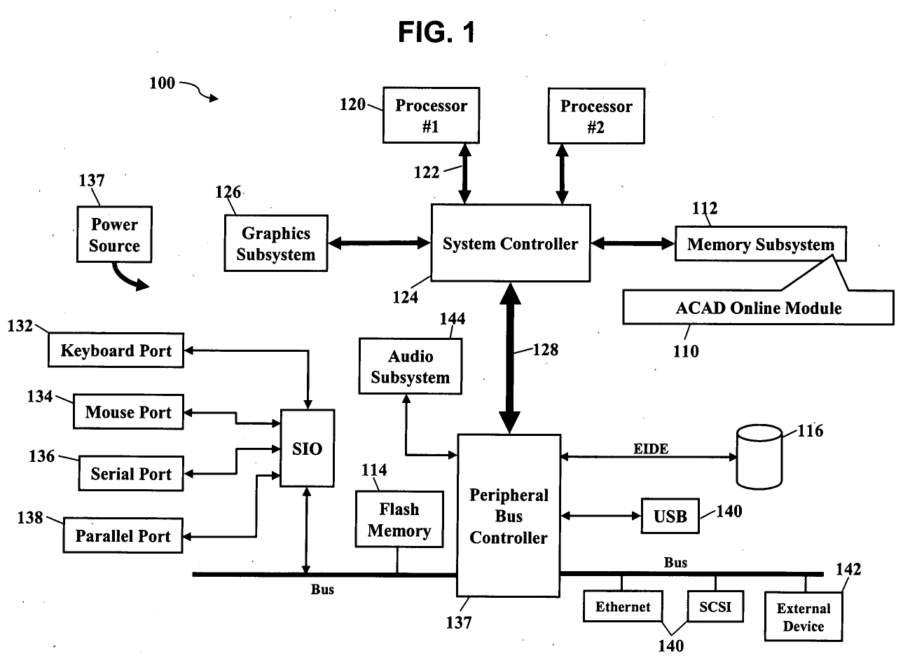

Referring now to the figures, FIG. 1 is a block diagram illustrating an access carrier customer service rates and billing details application manager referred to as an “ACAD Online 316 Module” 110, residing in a client workstation, shown as a personal computer 100. The ACAD Online Module 110 operates within a system memory device. The ACAD Online Module 110, for example, is shown residing in a memory subsystem 112. The ACAD Online Module 110, however, could also reside in flash memory 114 and/or in a peripheral storage device, such as storage device 116. The personal computer 100 also has one or more central processors 120 executing an operating system. The operating system, as is well known, has a set of instructions that control the internal functions of the personal computer 100. A system bus 122 communicates signals, such as data signals, control signals, and address signals, between the central processors 120 and a system controller 124 (typically called a “Northbridge”). The system controller 124 provides a bridging function between the one or more central processors 120, a graphics subsystem 126, the memory subsystem 112, and a PCI (Peripheral Controller Interface) bus 128. The PCI bus 128 is controlled by a Peripheral Bus Controller 130. The Peripheral Bus Controller 130 (typically called a “Southbridge”) is an integrated circuit that serves as an input/output hub for various peripheral ports. These peripheral ports could include, for example, a keyboard port 132, a mouse port 134, a serial port 136 and/or a parallel port 138. Additionally, these peripheral ports would allow the personal computer 100 to communicate with a variety of communications devices through Wired Comm Device Port 140 (such as, SCSI, USB, modem V90+, compact flash slots, Ethernet, and the like) and Wireless Transceiver 142 (such as, the IEEE Wireless standard 802.11, the Industrial and Scientific Band of the electromagnetic spectrum, and Infrared). The Peripheral Bus Controller 130 could also include an audio subsystem 144. Still further, the personal computer 100 may include a power source 160, such as a rechargeable battery, to provide power and allow the personal computer 100 to be portable.

The processor 120 is typically a microprocessor. Advanced Micro Devices, Inc., for example, manufactures a full line of microprocessors, such as the ATHLON™ (ATHLON™ is a trademark of Advanced Micro Devices, Inc., One AMD Place, P.O. Box 3453, Sunnyvale, Calif. 94088-3453, 408.732.2400, 800.538.8450, www.amd.com). Sun Microsystems also designs and manufactures microprocessors (Sun Microsystems, Inc., 901 San Antonio Road, Palo Alto Calif. 94303, www.sun.com). The Intel Corporation manufactures microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com).

The preferred operating system is a UNIX®-based system (UNIX® is a registered trademark of The Open Group, 44 Montgomery Street, Suite 960, San Francisco, Calif. 94104, 415.374.8280, www.opengroup.org). Other operating systems, however, may be suitable. Such other operating systems would include a LINUX® or a RED HAT® LINUX-based system (LINUX® is a registered trademark of Linus Torvalds and RED HAT® is a registered trademark of Red Hat, Inc., Research Triangle Park, N.C., 1-888-733-4281, www.redhat.com) and Mac® OS (Mac® is a registered trademark of Apple Computer, Inc., 1 Infinite Loop, Cupertino, Calif. 95014, 408.996.1010, www.apple.com). Another operating system would include DOS-based systems. WINDOWS® and WINDOWS NT® are common examples of DOS-based systems (WINDOWS® and WINDOWS NT® are registered trademarks of Microsoft Corporation, One Microsoft Way, Redmond Wash. 98052-6399, 425.882.8080, www.microsoft.com).

The system memory device (shown as memory subsystem 112, flash memory 114, and/or peripheral storage device 116) may also contain one or more other application programs. For example, another application program may cooperate with the operating system and with a video display unit (via the serial port 136 and/or the parallel port 138) to provide a Graphical User Interface (GUI) for the ACAD Online Module 110. The GUI typically includes a combination of signals communicated along the keyboard port 132 and the mouse port 134. The GUI provides a convenient visual and/or audible interface with the user of the personal computer 100. As is apparent to those of ordinary skill in the art, the selection and arrangement of the ACAD Online Module 110 may be programmed over a variety of alternate mediums, such as, for example, a voice-activated menu prompt.

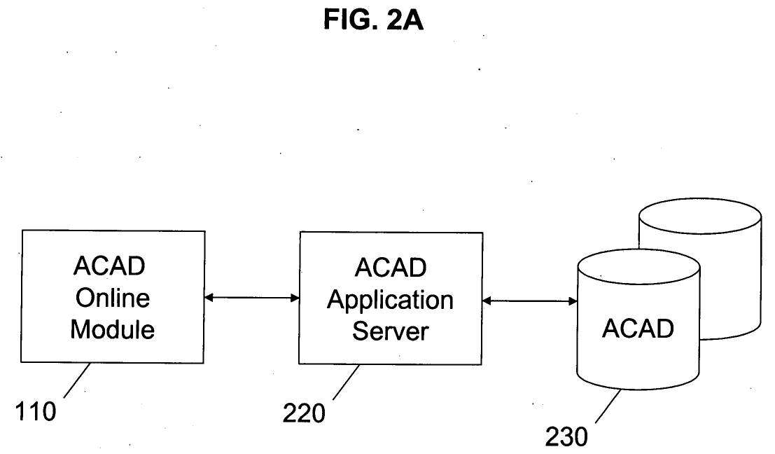

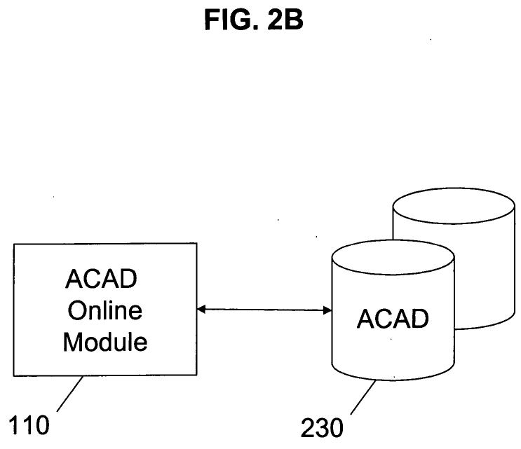

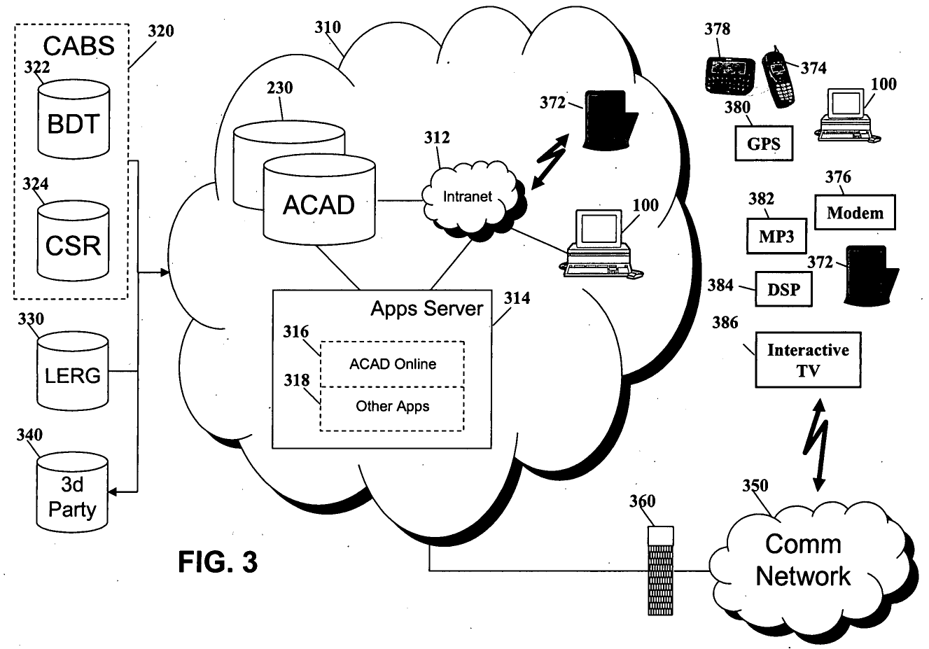

As shown in FIGS. 2A, 2B, and 3, an access carrier customer rate and billing detail system may be based on a distributed, client/server architecture that supports object oriented technology, messaging, transactions, security, system management, and/or reporting. According to an embodiment of this invention, a three-tier technical architecture consists of a client system (shown as reference numerals 100, 372, 374, 376, 378, 380, 382, 384, and 386 in FIG. 3) operating with an ACAD Online Module 110, an application server shown as ACAD application server 220, and a database server operating with ACAD database 230 as shown in FIG. 2A. According to another embodiment of this invention, a two-tier technical architecture consists of a client system (shown as reference numerals 100, 372, 374, 376, 378, 380, 382, 384, and 386 in FIG. 3) operating with an ACAD Online Module 110, and a database server operating with the ACAD database 230 as shown in FIG. 2B. Referring now to FIG. 3, the ACAD Online Module 110 operates on a client workstation that may be a component on a private network, such as business network 310. Alternatively, the client workstation may be stand alone or integrated into a third party workstation, such as a personal digital assistant 372, a mobile phone 374, a modem 376, an interactive pager 378, a global positioning system 380, a digital media player 382 (such as an MP3/4 device), a digital signal processor 384, interactive television 386, and/or stand alone computer 100. If a stand alone or third party workstation is used to gain access to network 310, then the alternate workstation connects to business network 310 through communications network 350 and firewall 360. Whatever hardware and/or software of the client workstation, the client workstation provides a Graphical User Interface (GUI) for viewing and interacting with an ACAD Online application 316. Further, the ACAD application server 220 and the database server are multi-user computer systems, e.g., UNIX-based servers. Still further, it should be understood that multiple client systems and programs might be distributed throughout a network. Furthermore, several application servers running multiple applications may be located at various places, and multiple database servers and databases may be distributed as well.

Typically, a user (e.g., a telco employee) uses his/her workstation, such as personal computer 100 or PDA 372, to interact with ACAD Online Module 110 and gain access via an Intranet 312 to ACAD Online 316 (or alternate other applications shown as reference numeral 318) residing on application server 314. The user navigates through one or more GUIs to login, access, generate, and/or modify access carrier service customer rate and billing detail. ACAD Online 316 retrieves rate and billing data from ACAD database 230, performs any required business logic, and formats and displays information via ACAD Online Module 110 to the client workstation. Further, ACAD database 230 communicates with legacy systems and a third party system 340 to access and selectively store rate and billing information. The legacy systems include Carrier Access Billing System (CABS) 320 databases including Billing Data Tape (BDT) 322 and Customer Service Record file (CSR) 324 and Local Exchange Routing Guide (LERG) 330. The CABS CSR and BDT detail is an industry standard stipulated in the CABS Billing Output Specification (CBOS).

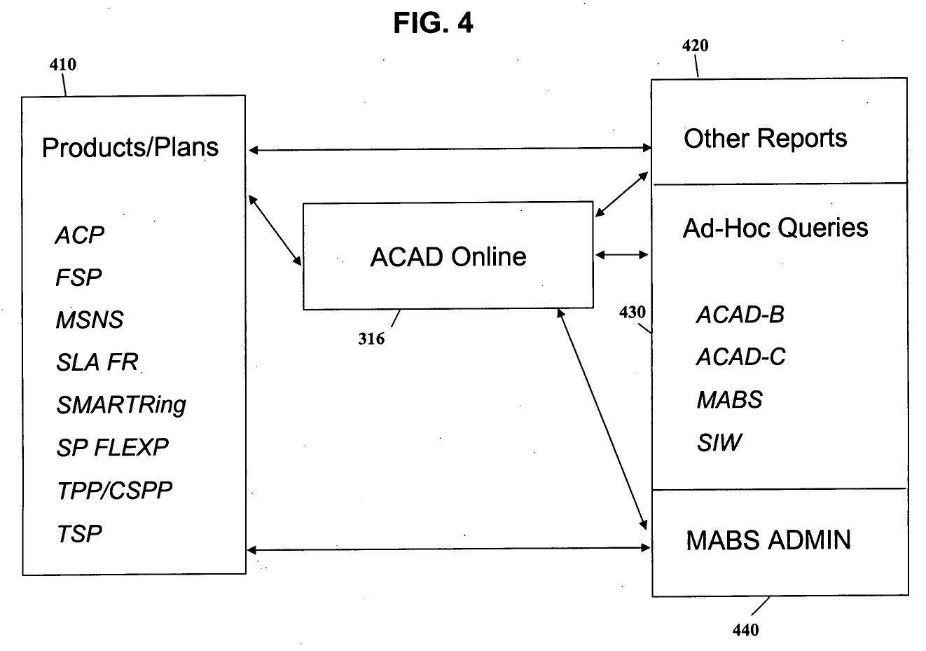

ACAD Online 316 is a tool used by sales, marketing, operations and general staff personnel for standard reporting, sales proposals, customer billing dispute resolution, product analysis & development, updates to discount plans, input of billing adjustments, and/or modifications to rate and billing data. In an embodiment, ACAD Online 316 is a menu driven BrioQuery® application that accesses the ACAD database 230 with an ODBC connection over the business network 310 (typically a wide area network and/or a local area network). ACAD Online 316 utilizes standard BrioQuery® database queries, MS Access® applications, and MS Excel® spreadsheets to provide a suite of tools that produce carrier access service customer rate and billing detail. As shown in FIG. 4, ACAD Online tool suite includes intelligent reporting capabilities for access service products and plans 410. These products and plans 410 include Area Commitment Plan (ACP), Fast Packet Savings (FSP) plans, Managed Shared Network Services (MSNS), Service Level Agreement (SLA), Self-healing Multi-Nodal Alternate Route Topology Ring (SMARTRing), Special (SP) Pricing Flexibility (SP FLEXP) Contract by Contract Number, Transport Payment Plan/Channel Service Payment Plan (TPP/CSPP), and Transport Savings Plan (TSP). ACAD Online 316 also includes other reports 420 including Circuit Scan (not shown), Class of Service (COS) groups and descriptions, and Credits & Adjust. Further, ACAD Online 316 includes intelligent data models for ad-hoc queries 430 that allows the user to produce rate and revenue detail without requiring the user to have an understanding of the underlying ACAD database schema and architecture. These ad-hoc query models 430 include a total billed revenue model (ACAD-B) built from CABS billing and customer service data, and a circuit level detail model (ACAD-C) built from CABS customer service data, MABS built from CABS data stored on legacy system tables, and Strategic Information Warehouse (SIW) containing account, address, billing, Universal Service Order Code (USOC), and working line service/product information of RBOC Customer Records Information System (CRIS) residential and business customer's local service. Still further, ACAD Online 316 includes MABS administration 440 that can only be accessed by a select group of users and/or administrators for additional processing and creation of customer billing credits.

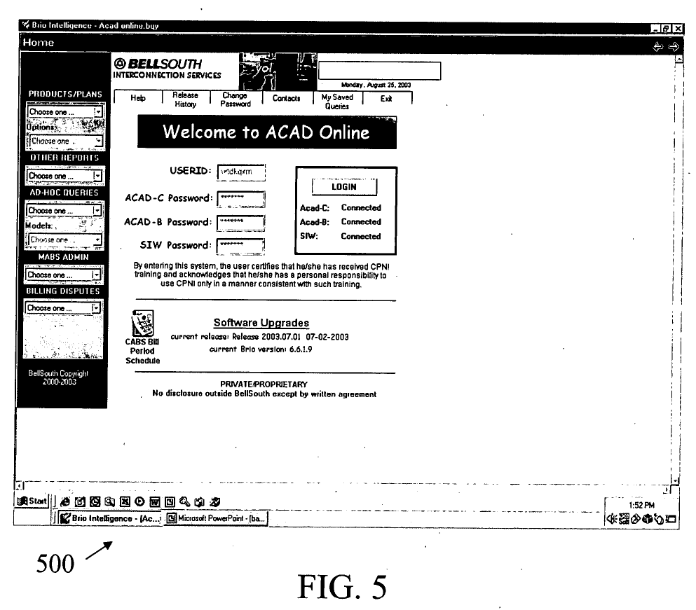

An exemplary overview of ACAD Online 316 including exemplary carrier access service customer rate and billing details will now be discussed with reference to FIGS. 5-35. FIG. 5 illustrates an exemplary ACAC Online entry screen 500. On its main screen (“Home”), the user must first log into the appropriate databases before navigating to any other part of the system. The screen 500 provides data security by limiting access to those users with the proper database permissions. The screen 500 contains queries that identify the current bill periods and/or months for each of the databases. This information can be used by other executable programs in the system. This entry screen also contains global scripts that are used throughout ACAD Online 316. This global scripts remain open “behind the scenes” during the entire session so that these scripts are available for use by other documents.

Text labels in the top bar can be clicked to activate other sections within the BrioQuery® that provide the following functionality:
Help—Provides command buttons that open User Guides for databases ACAD-B and ACAD-C and for the ACAD Online 316 application. Also, Help provides dropdowns that correspond to the various sidebar options; when selected, the database(s) the user must log into for that option are displayed. This screen also contains command buttons that open documents describing how to install a driver and how to create PDF for many of the details (i.e., generated pivot reports) described below.
History—Provides a listbox of ACAD Online 316 releases and their install dates. When selected, text labels detail the changes included in that release.
Change Password—Provides a means for the user to change their ACAD-B, ACAD-C, and/or database passwords before they expire.
Contacts—Provides a list of contacts.

Finally, a text label entitled “Upgrade Software” will take the user to a screen which displays information about the current ACAD Online 316 release; when the command button “Upgrade NOW” is clicked, any new software associated with that release is automatically installed.

ACAD Products/Plans

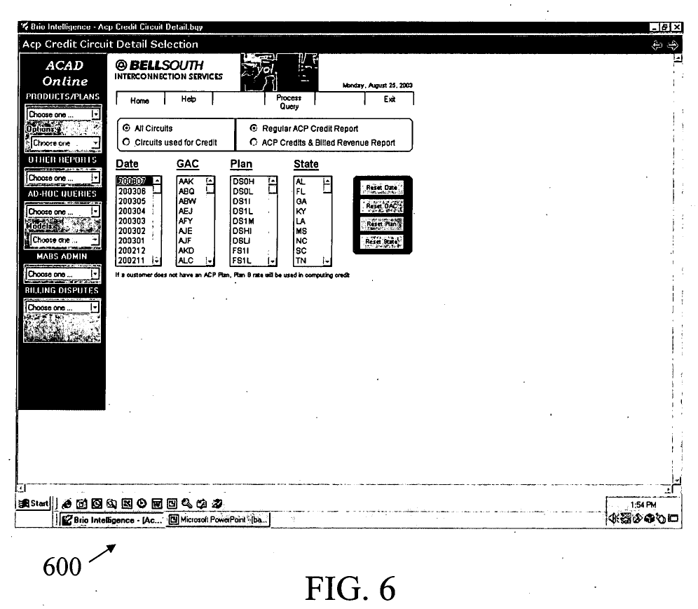

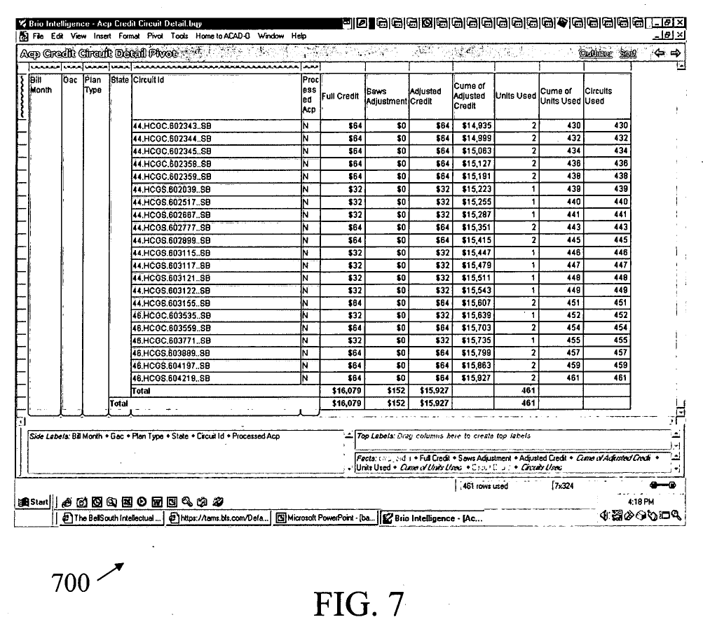

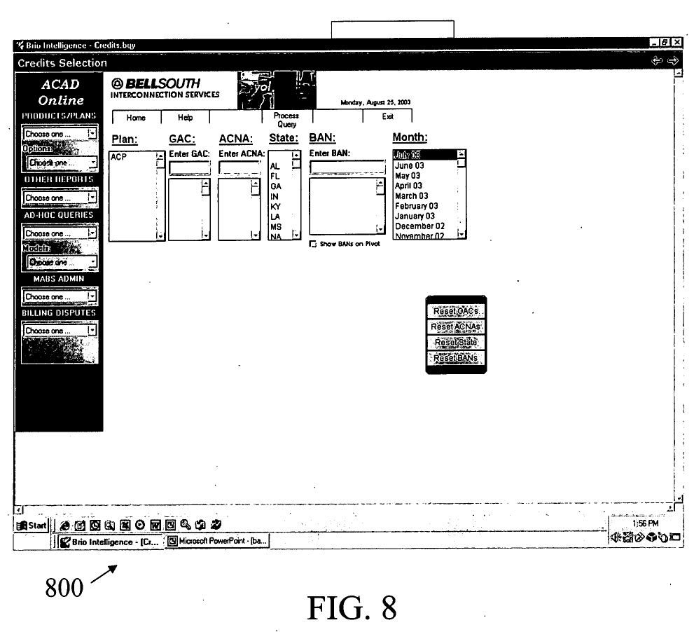

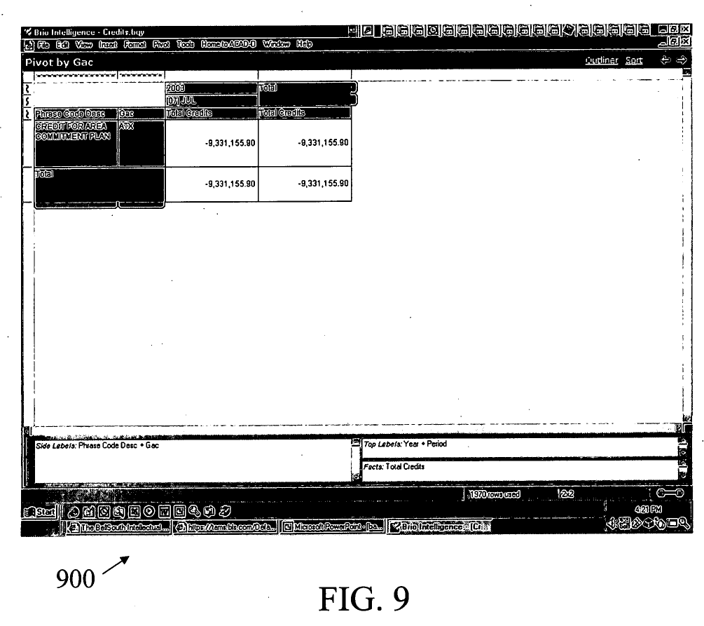

FIG. 6 illustrates a GUI for an Area Commitment Plan (ACP) credit information selection screen 600 for selecting month, GAC, plan type, state and circuit level. The screen 600 is sourced from ACP data extracted from CABS. The screen 600 provides options to select the Date, Group Access Code (GAC), Plan, and State that are used to define the detail selection criteria. Once the query is processed, a pivot ACP Credit Circuit Detail is placed at the bottom of the screen with a pointer to the pivot section. FIG. 7 illustrates the resulting ACP Credit Circuit Detail 700. FIG. 8 shows a GUI for an ACP plan Other Charges and Credits (OC&C) credits selection screen 800 stored in ACAD-B database and produces an ACP plan OC&C credits detail 900 shown in FIG. 9 based on the selections.

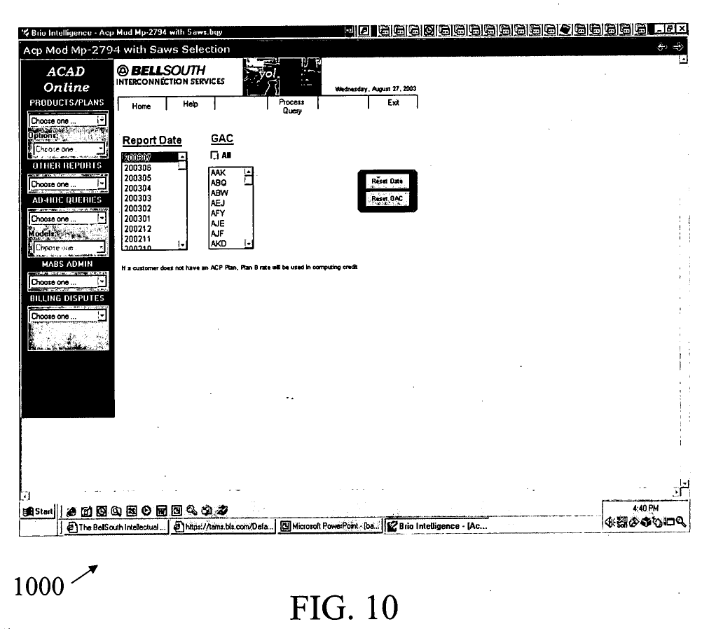

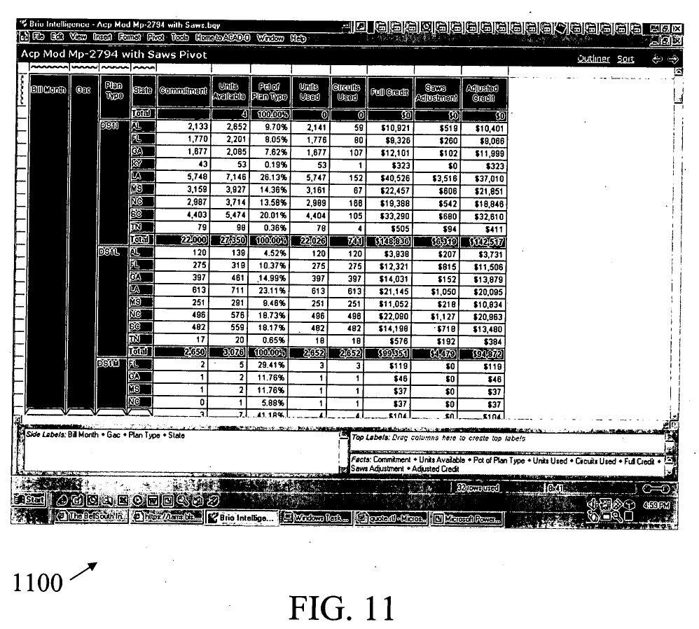

FIG. 10 depicts a GUI for a modified version of a Mechanically Produced (MP-2794) report (ACP MOD MP-2794) selection screen 1000. The ACP MOD MP-2794 selection screen 1000 displays the Carrier ACP commitment and adjustment detail such as units available, units used, commitments and credits by month, GAC and State. The ACP MOD MP-2794 selection screen 1000 is sourced from the ACP Billing and Plan data extracted from CABS tables. The ACP MOD MP-2794 selection screen 1000 provides options to select the date and GAC that are used to define the report selection criteria. Once the query is processed, the user has the choice to view an ACP MOD MP-2794 detail shown as reference numeral 1100 in FIG. 11 or printing to a file. The ACP MOD MP-2794 detail 1100 is grouped by plan type and contains graphs comparing commitments to units available. In addition, a condensed version of the detail 1100 can be exported to a Microsoft Excel® spreadsheet.

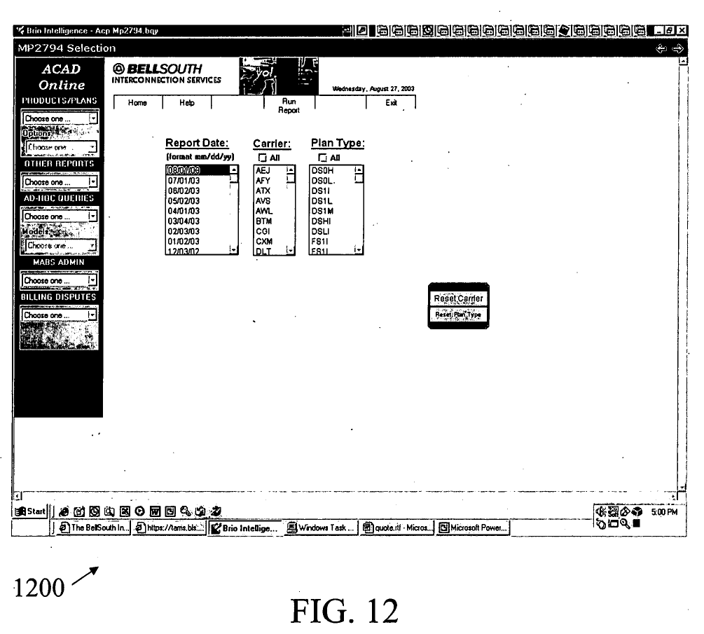

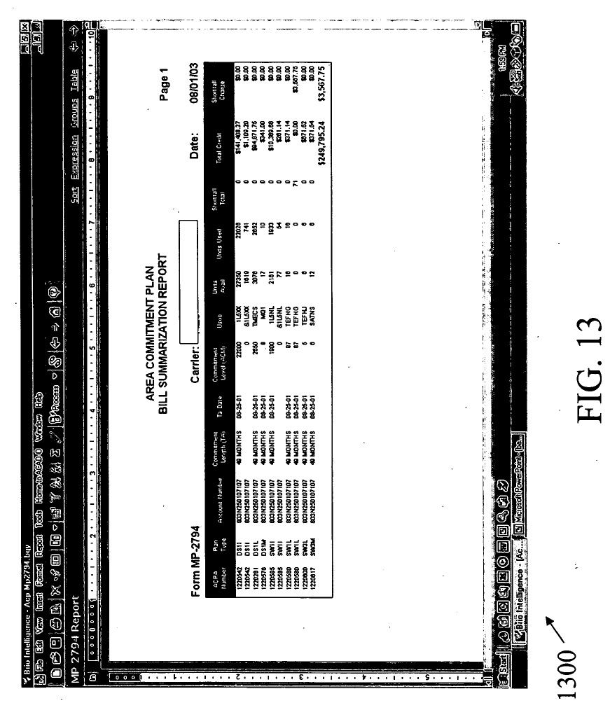

FIG. 12 illustrates a GUI for an ACP MP-2794 selection screen 1200. The ACP MP-2794 selection screen 1200 reports by Carrier showing the ACP Plan Type, the customer's commitment level, the units used and available, the total credit, and any shortfall charges. FIG. 13 is a GUI of the resulting MP-2794 detail 1300.

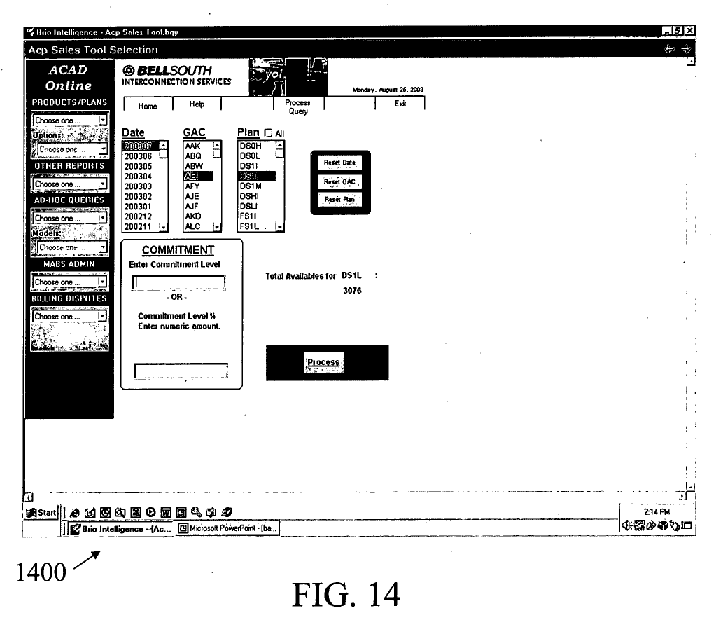

ACAD Online 316 maintains data for sixteen (16) Special Access ACP Plans and five (5) Switched Access ACP Plans. For each, the user can retrieve a pre-defined set of information that can then be submitted to a Microsoft Access program in order to calculate the amount of credit the customer would receive if they were to sign up for the savings plan. FIG. 14 illustrates a GUI for ACP simulation selection screen 1400. The user selects the plan(s) he/she is interested in and then supplies the GAC, ACNA, and Month. Queries are then run against the ACAD-C databases to retrieve the records that meet the criteria for that plan. For each plan type selected, a text file is created from the results set and is then saved to the user's hard drive with a unique name in a designated folder. After processing all the selected plans, the Microsoft Access program is launched and an ACP simulation detail based on the selections is generated (not shown).

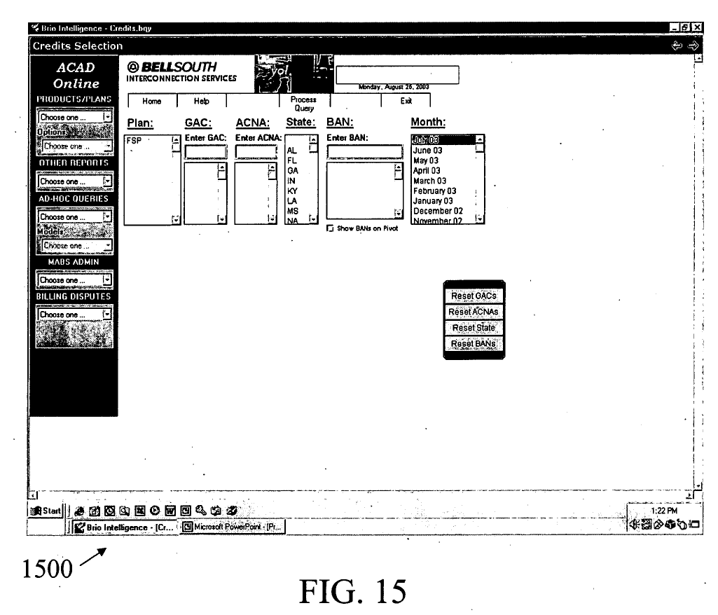

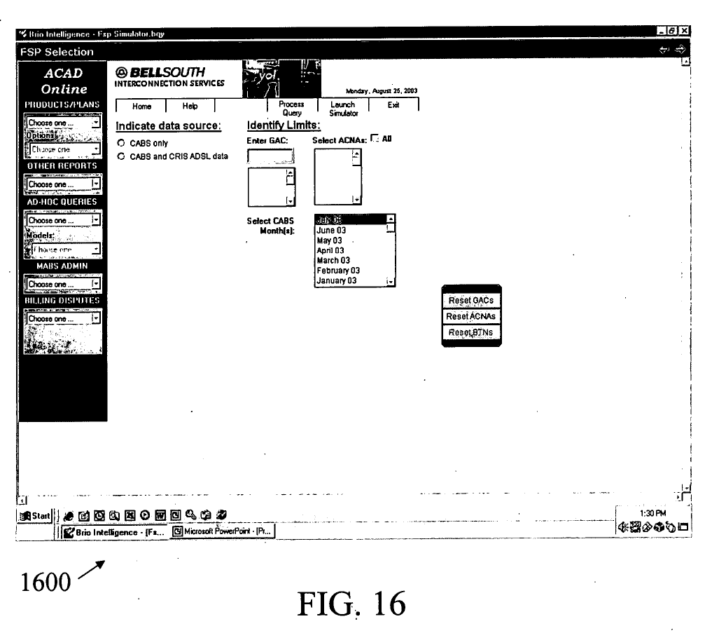

FIG. 15 illustrates a GUI for a Fast Packet Savings (FSP) plan OC&C credits selection screen 1500 from the data stored in the ACAD-B database and based on the user's selection criteria. The query limits by phrase code based on the plan type option selected by the user. For FSP, the phrase code is set to Z04. FIG. 16 illustrates a GUI for launching an FSP simulator selection screen 1600. The FSP simulator creates text files for the FSP Plan from CABS data or CABS and CRIS ADSL data. A separate file is created for each data source that is then saved to the user's hard drive with a unique name in a designated folder. After processing all the selected plans, a Microsoft Access® program is launched that uses the file in its report generation. The user chooses GACs, ACNAs, and Bill Months. If the choice is made to include CRIS ADSL data, the user must then enter billing numbers, also.

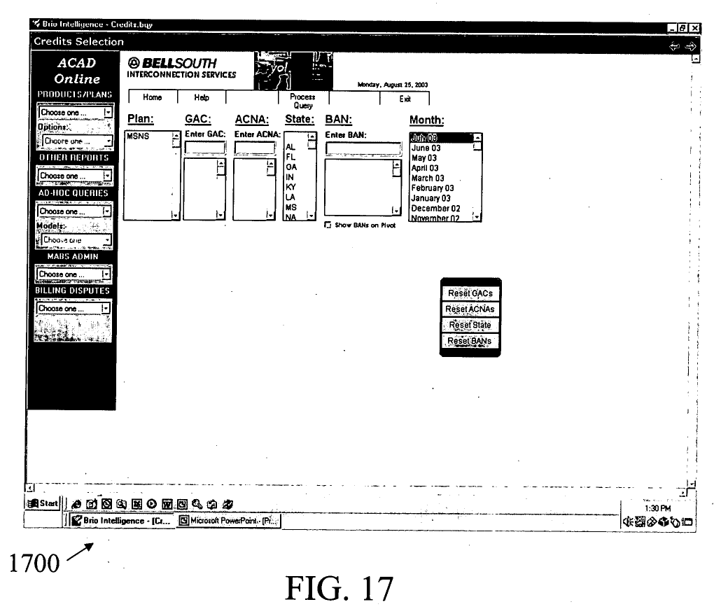

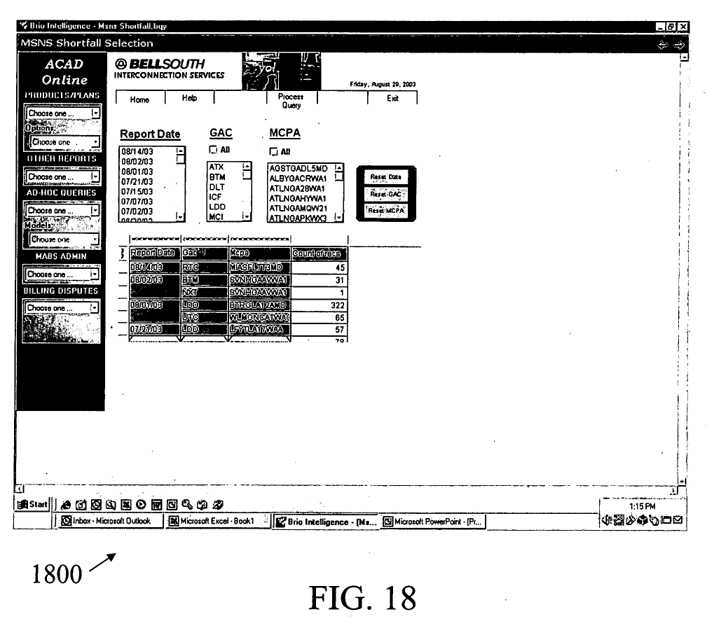

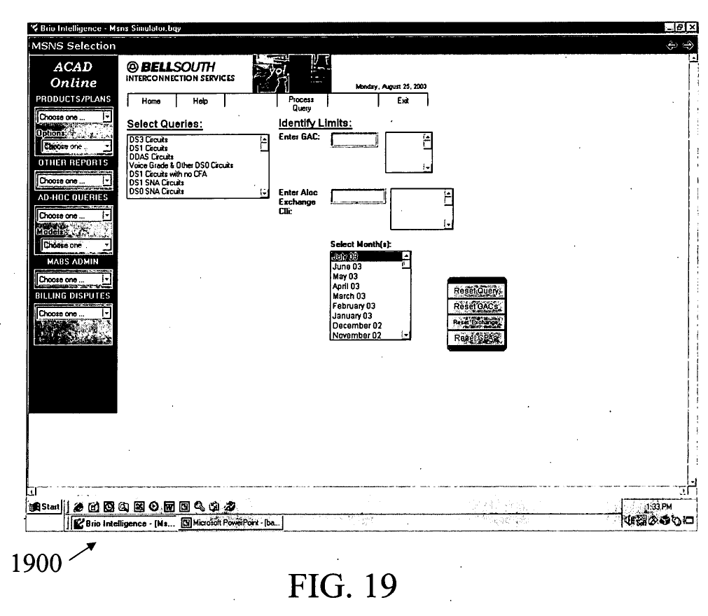

FIG. 17 illustrates a GUI for a Managed Shared Network Services (MSNS) selection screen 1700. Using the selection screen 1700, the user selects one or more GACs and one or more associated Managed Commitment Plan Arrangements (MCPAs) for those GACs. A query is then run to produce a report that shows the Point of Presence (POP) Common Language Location Identifier (CLLI) Addresses, the ACTLs, the Service Type of those ACTLs, and any user-defined notes for the selected GAC/MCPA. In addition, an MSNS plan OC&C credits detail stored in ACAD-B may be generated. The MSNS plan OC&C credits detail may be limited by phrase code based on the plan type option selected by the user. For MSNS, the phrase code is set to D70 and Z60. FIG. 18 illustrates a GUI for a CABS MP-10522 Shortfall selection screen 1800. The MP-10522 Shortfall detail (not shown) displays GACs by MCPA and ACM that had MSNS shortfall. It contains shortfall data extracted from CABS. The selection screen 1900 provides the options to select the date, GAC, and MCPA that are used to define the report criteria. A detail may be shown at the bottom of the selection screen 1900 that lists a summary of shortfall data. FIG. 19 illustrates a GUI for launching an MSNS Simulator selection screen 1900. The user inputs selections to run a query that identifies the ACAD-C MSNS circuits: circuit type (i.e. DS3, DS1, etc.), GAC, ALOC Exchange Common Language Location Identifier (CLLI), and Month. Connecting Facility Assignments (CFAs) may also have to be entered depending on the circuit type selected.

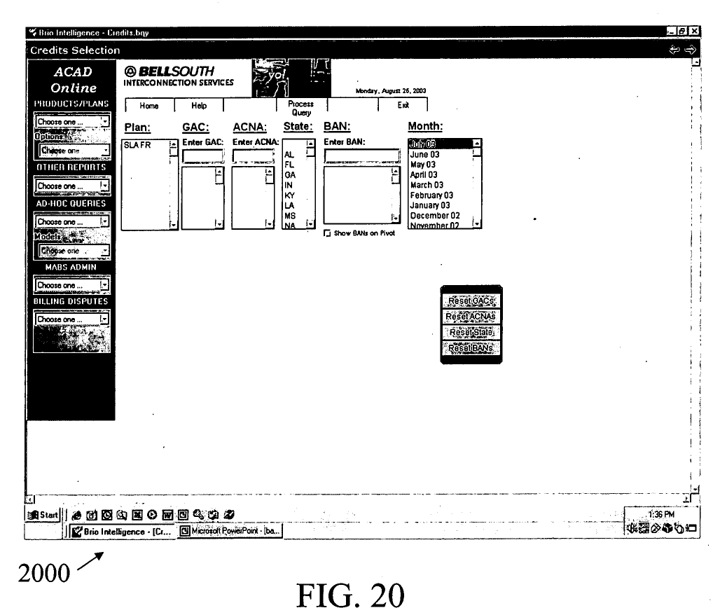

FIG. 20 illustrates a GUI for generating an SLA (Service Level Agreement) for Frame Relay (FR) plan OC&C credits 2000 stored in ACAD-B based on the user's selection criteria and produces the SLA for Frame Relay plan OC&C detail (not shown). The query limits by phrase code based on the plan type that the option is called from. For SLA FR, the phrase code is set to ZBF.

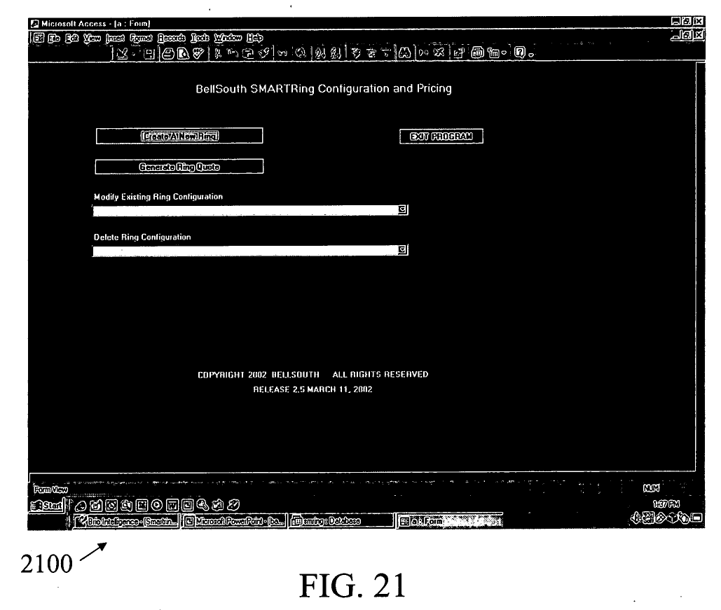

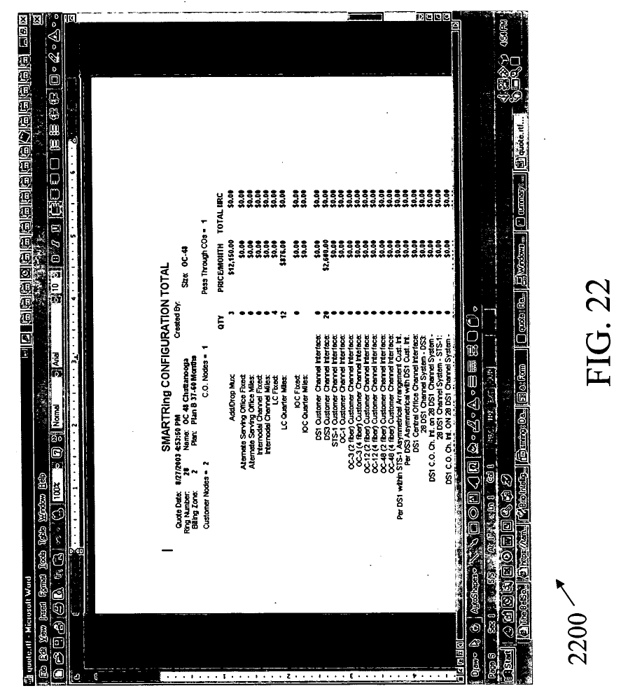

FIG. 21 illustrates a GUI for generating a SMARTRing detail 2100 that launches a Microsoft Access® program to allow the user to create various SMARTRing Sales proposal scenarios. FIG. 22 illustrates a GUI of a resulting SMARTRing sales proposal report 2200.

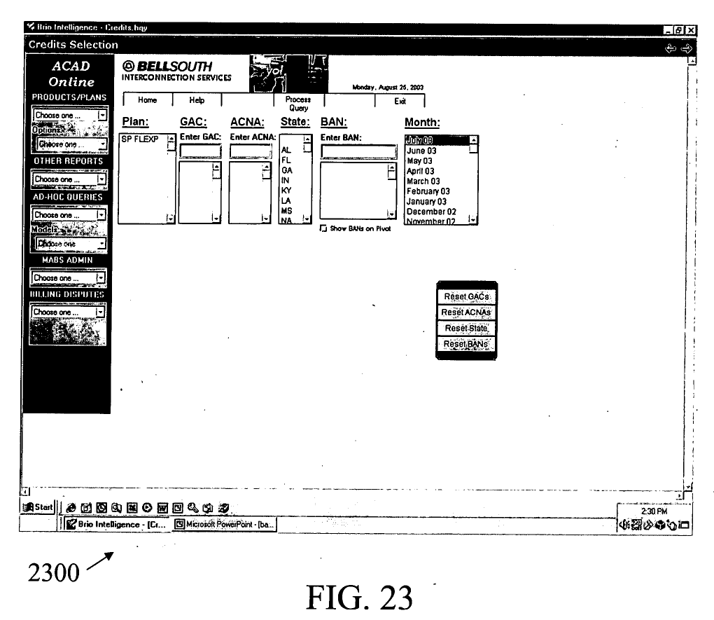

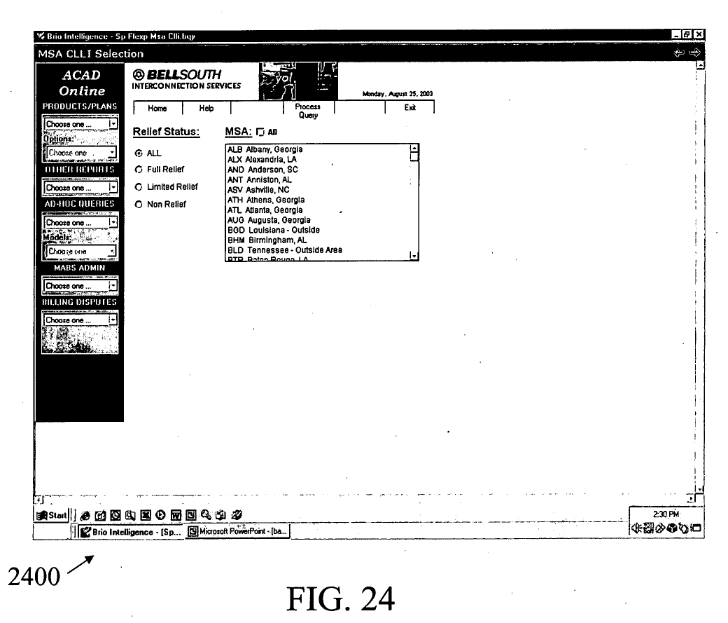

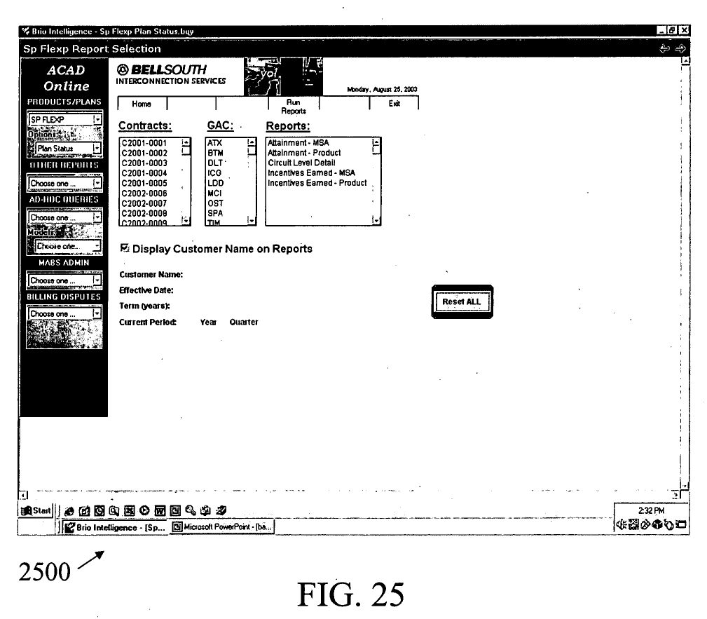

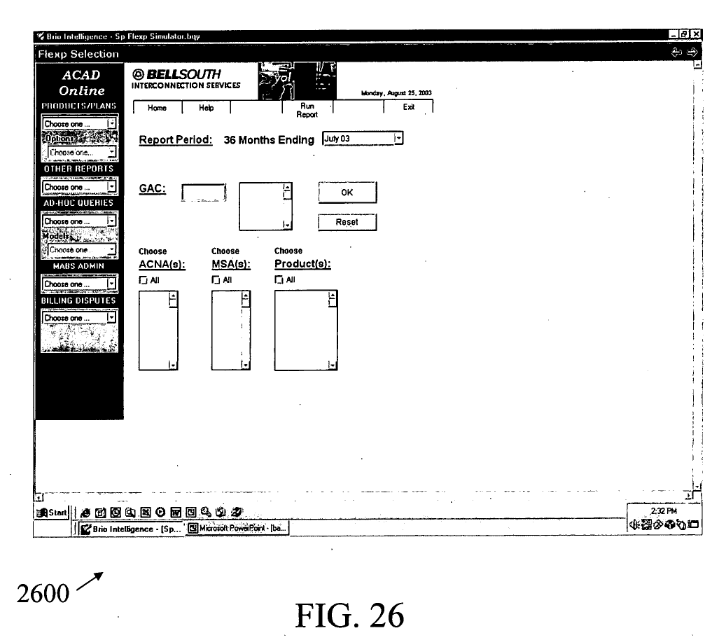

FIG. 23 illustrates a GUI for generating a Pricing Flexibility (e.g., Special Access Flexible Pricing (SP FLEXP)) selection screen 2300. The resulting detail shows all the terms, commitments and credits associated with an SP FLEXP contract. It is sourced the SP FLEXP contract extracted from the SP FLEXP Contract Tool. The selection screen 2300 provides the option to select the Contract ID that is used to define the detail criteria. In addition, a SP FLEXP plan OC&C credits screen (not shown) limited by phrase code based on the plan type may also be generated. For SP FLEXP, all phrase codes ZAD, ZAG, ZAI, ZAH, ZAE, ZAJ, ZAF, ZAL, ZAK, ZAU, ZAW, ZAN, ZAT, ZAM, ZAS, ZBM, ZBN, ZBO, and ZBP may be extracted. FIG. 24 illustrates a GUI for generating a SP FLEXP Metropolitan Statistical Area (MSAs) detail 2400. The user selects one or more MSAs and then indicates if All MSAs, Full Relief MSAs, Limited Relief MSAs, or Non Relief MSAs should be included. FIG. 25 illustrates a GUI for accessing five details pertaining to SP FLEXP revenue and credits 2500. The Attainment—MSA detail displays the SP FLEXP Regional level revenue attainment by GAC and Contract. The user has the option of choosing the date range on the report. The report displays the YTD revenue and commitment target in graphical representation and computes a percent attainment. It also displays a pivot of revenue by MSA and Bill Month. The Attainment—Product detail displays the SP FLEXP Regional level Product Suite revenue attainment by GAC and Contract. The user has the option of choosing the date range on the detail. The detail displays the YTD Product Suite revenue and commitment target in graphical representation and computes a percent attainment. It also displays a pivot of Product Suite revenue by MSA and Bill Month. The Circuit Level Detail displays SP FLEXP revenue at circuit level by Customer and Contract. The user has the option of choosing the date range on the report. The Incentives Earned—MSA detail displays regional SP FLEXP Regional and Product Suite credits accrued by Customer and Contract. The user has the option of choosing the date range on the report. The credit amounts are in Pivot format that are at MSA and Billing Account Number (BAN) level. The Incentives Earned—Product detail displays regional SP FLEXP Product Incentive credits accrued by Customer and Contract. The user has the option of choosing the year on the report. The amounts are at MSA and BAN level. FIG. 26 illustrates the GUI for launching the SP FLEXP Simulator 2600. The SP FLEXP Simulator is a Sales Tool for the SP FLEXP Credits team. The SP FLEXP Simulator displays the revenue trends by Carrier and aids sales personnel in computing contract commitments. The SP FLEXP Simulator detail is a single report that combines charts, pivots and computed fields to reveal 3 years of annual revenue and trending percentages. The data is grouped by GAC, MSA, and product and revenue is displayed at the Total, Relief qualifying and product level.

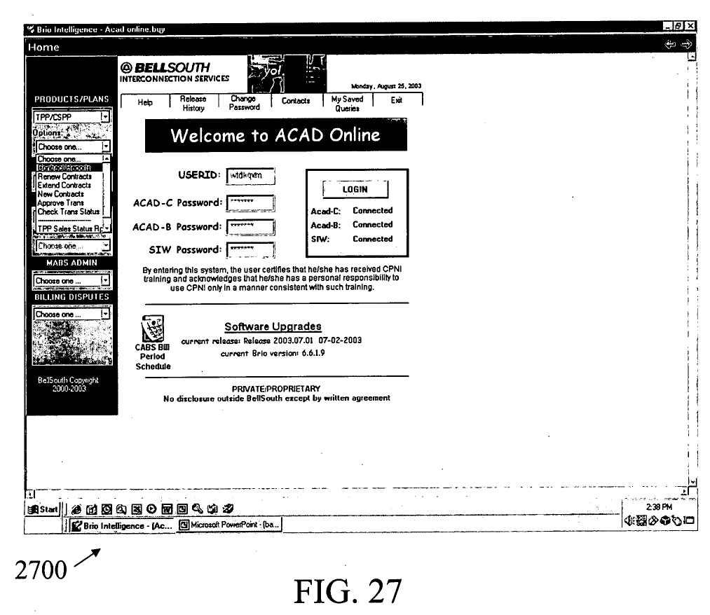

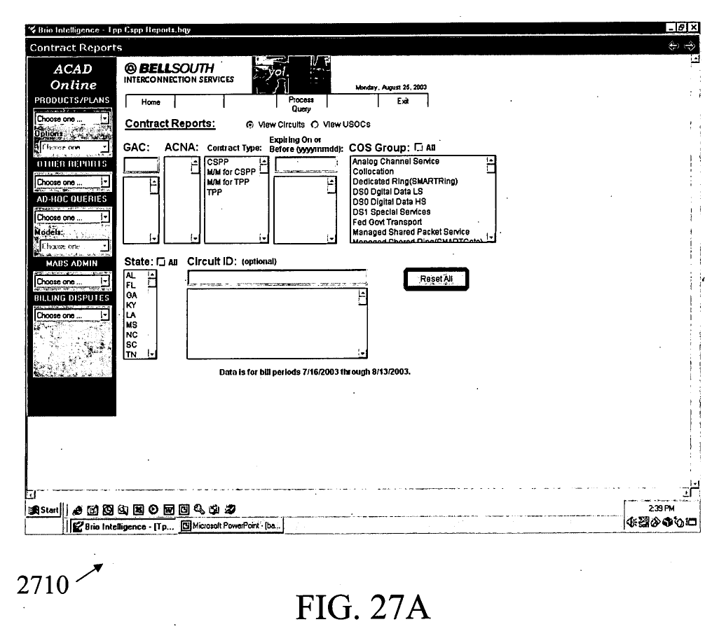

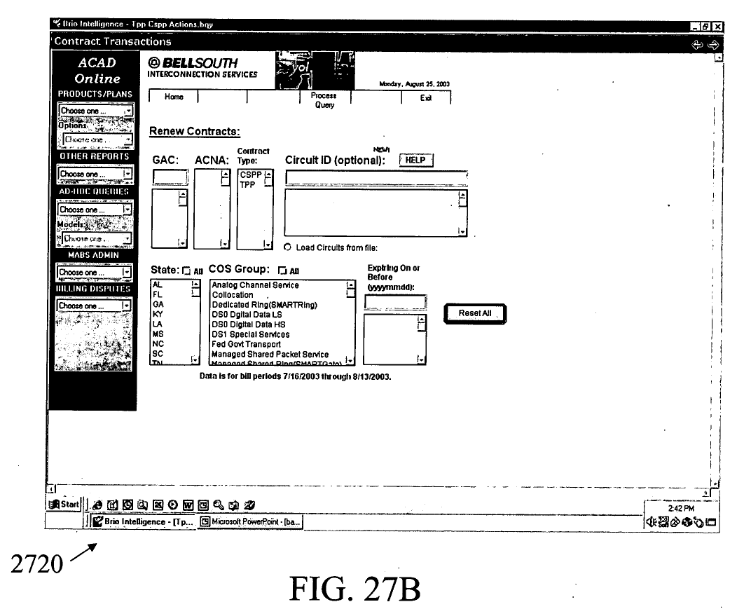

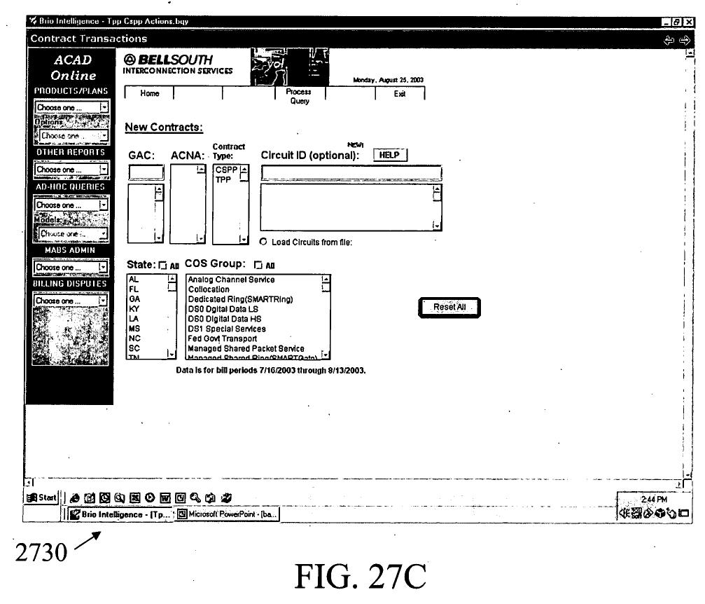

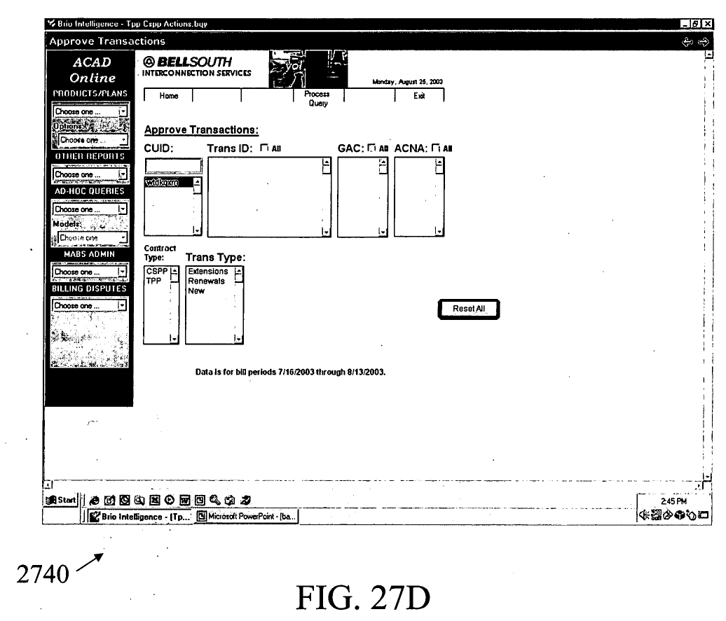

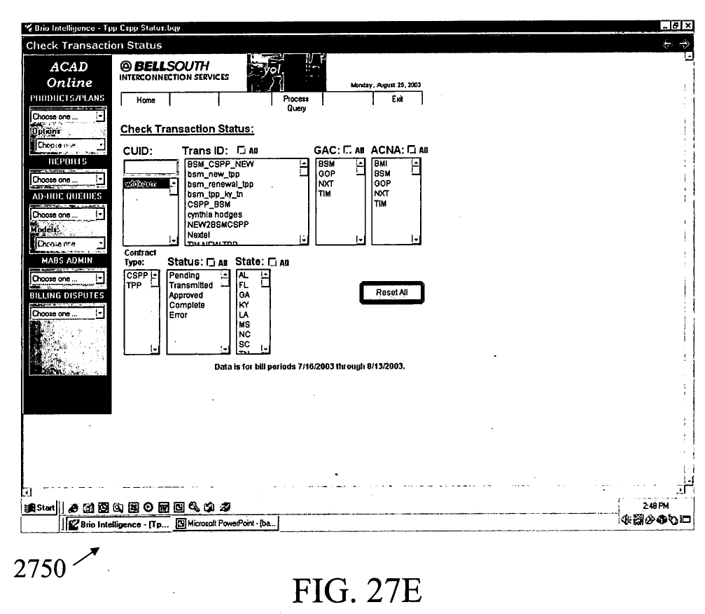

FIG. 27 illustrates a GUI for a TPP/CSPP selection screen 2700. The user can use the selection screen 2700 to create details of customers with TPP or CSPP contracts or customers who currently do not have one of these contracts (currently month to month full rate basis), but are eligible to have one. The selection screen 2700 allows the user to do access other GUIs (shown as reference numerals 2700A-E) to manage several different actions relating to TPP and CSPP contracts: 1) view existing contract details 2700A; 2) renew existing contracts using GUI 2700B; 3) extend existing contracts using GUI 2700C; 4) create new contracts on circuits that are currently month-to-month using GUIs 2700D; and 5) approve contract transactions using GUIs 2700E. To renew an existing contract, the user must enter the GAC, ACNA, contract type (TPP or CSPP), state, and class of service group of the circuits that need to be renewed. A date that the contract is expiring on or before must also be entered. When the “Process Query” label is clicked, a query is run against ACAD-C to bring back all selected circuits and display them on a separate GUI. The user then supplies the transaction id, an email address, the new contract term (months), the new rate date, the CABS effective date, and any notes for the circuits whose contracts he/she wished to renew. When a “Process” command button is clicked (e.g., the “Process” button displayed on the screen to generate the pivot detail report), the information supplied by the user is edited and then transactions are created for the selected circuits and stored. On the next bill date, approved records are sent to CABS where the contracts are renewed. To extend contracts, this option works almost identical to contract renewal with the only difference being that the user does not enter a new rate date. To enter a new contract, the user can obviously not enter a contract expiration date when querying the database since the goal is to identify circuits currently not under contract. With this one difference, the other steps are the same as for renewals and extensions. To approve renewed, extended, or new transactions, the user identifies the circuits by either CUID, transaction id, GAC, ACNA, contract type, or transaction type (extend, renew, new) and then indicates if the transaction should be approved or deleted. In addition, ACAD Online includes a GUI for allowing the user to check the status of previously submitted TPP/CSPP contract transaction (the GUI is not shown due to privacy regulations). When the contract transaction is selected and opened, it automatically queries the transactions belonging to the user's CUID and displays the data in selection list boxes. The user can then narrow the query by selecting additional criteria and click a “Process Query” label to run the query and produce a detail.

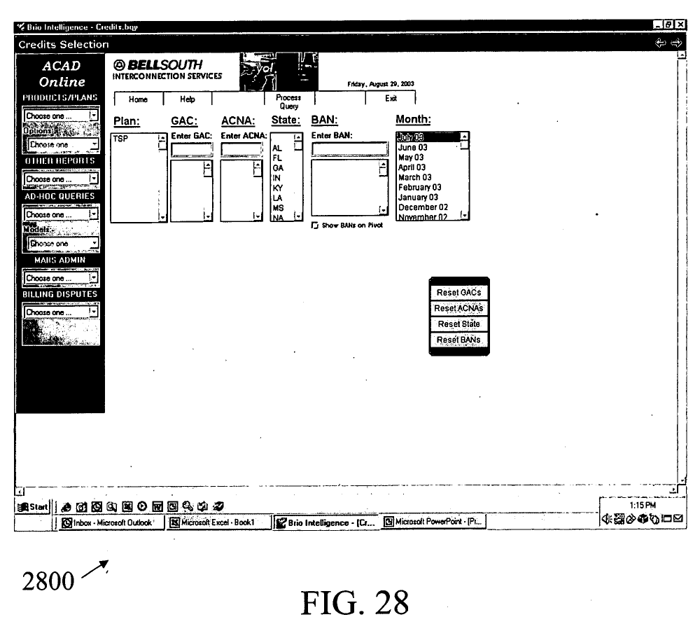

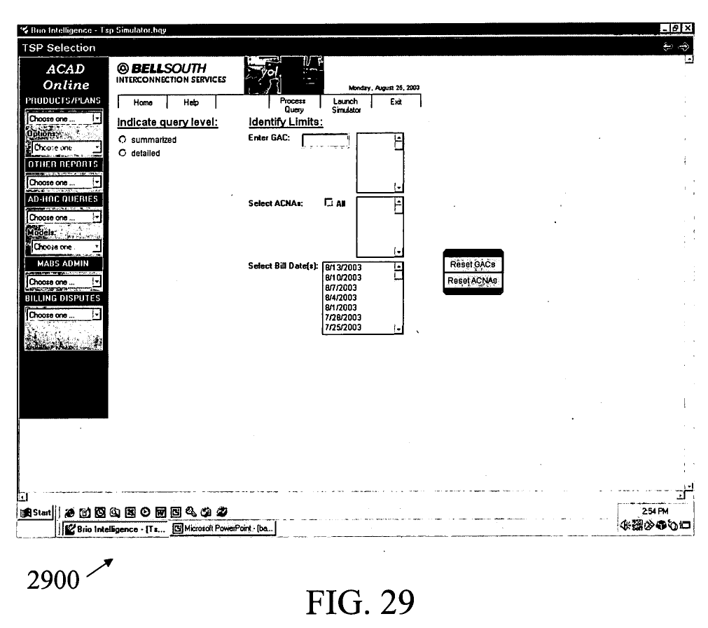

FIG. 28 illustrates a GUI for a Transport Savings Plan (TSP) selection screen 2800. The TSP detail (not shown) is based on TSP plan OC&C credits. The query limits by phrase code based on the plan type that the option is called from. For TSP, the phrase code is set to H39. FIG. 29 illustrates a GUI for launching a TSP Simulator 2900. Using the selection criteria, either a summarized text file for TSP or two detailed text TSP files, based on the user's selection of either a “summarized” or a “detailed” query level are provided. The files are then saved to the user's hard drive with a unique name in a designated folder. After processing, a Microsoft Access® program is launched that uses the files in its report generation. The user chooses one or more GACs, ACNAs, and Bill Dates.

ACAD Other Reports

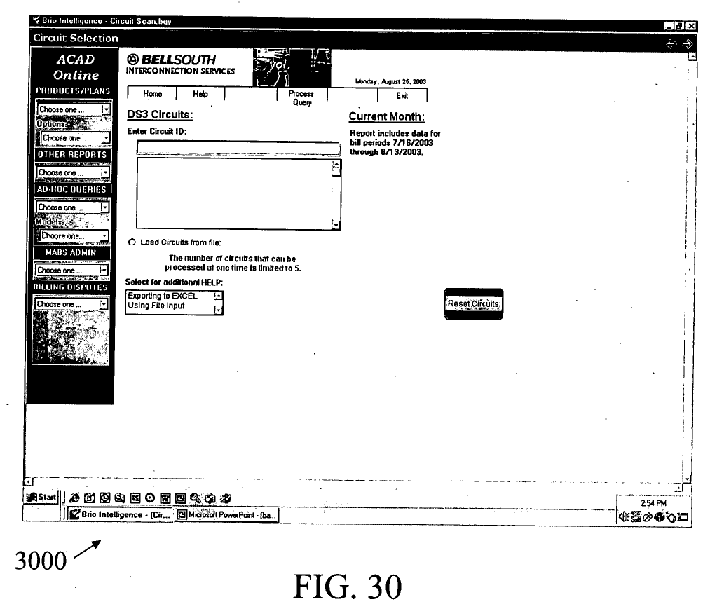

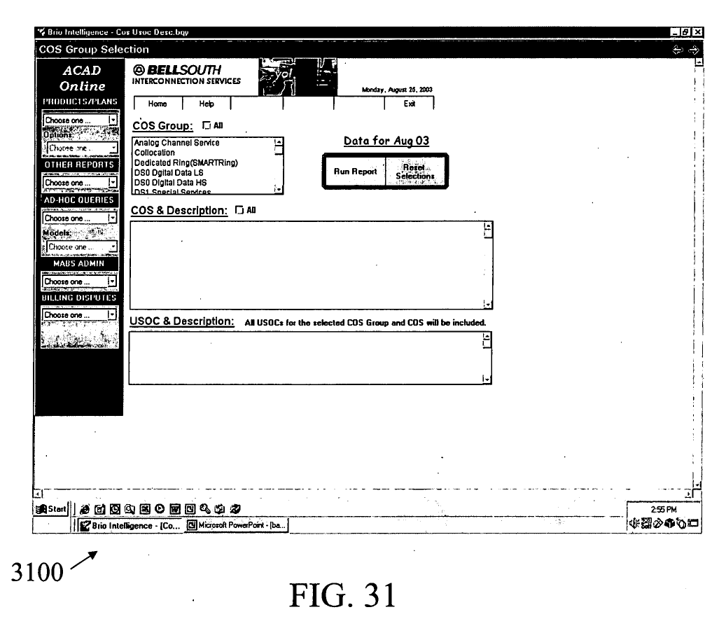

Other reports 420 may be generated using the GUIs 3000 and 3100 of FIGS. 30 and 31. FIG. 30 illustrates the GUI 3000 for circuits scanned based on selection criteria. FIG. 31 illustrates the GUI 3100 for generating a detail associated with the class of service (COS) and its description and the USOC and its description for each selected class of service group.

ACAD Ad-Hoc Queries

ACAD Online 316 includes pre-built data models that are used to access, read, merge, store, and maintain access carrier service rate and billing detail records. These data models can be used to build ad-hoc queries 430 without requiring the user to have an understanding of the underlying table joins in the ACAD-B or ACAD-C database.

ACAD-C Database

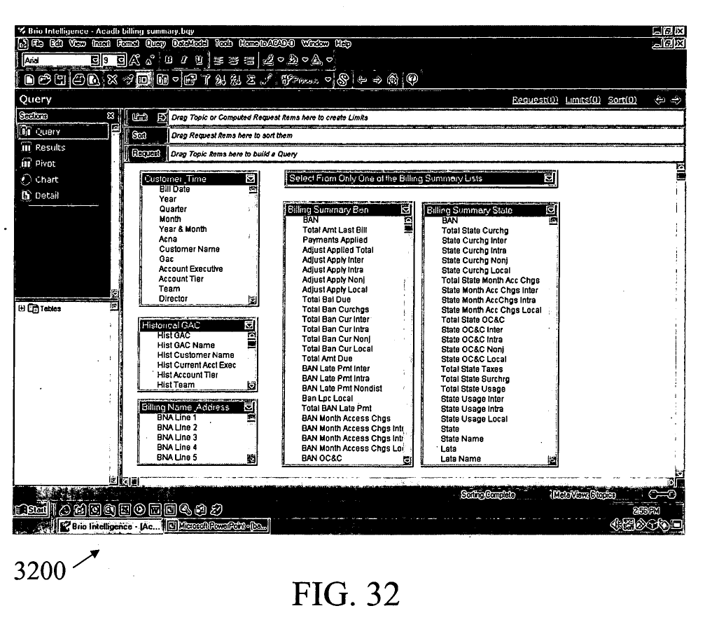

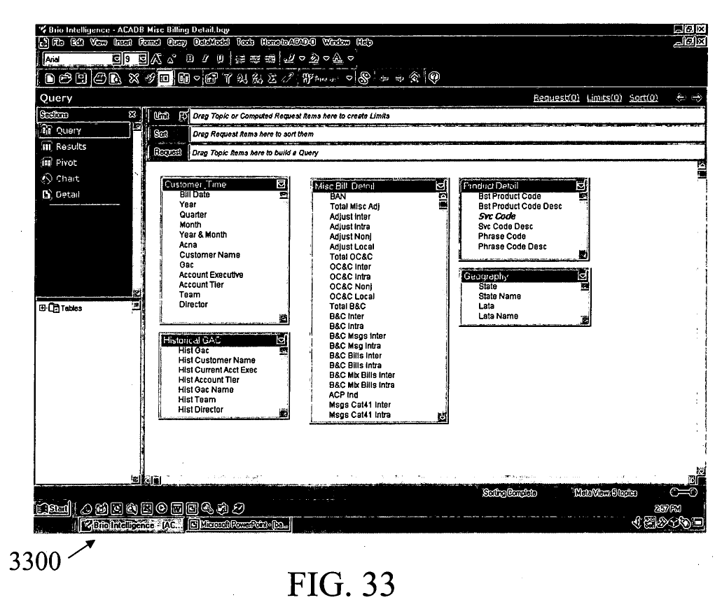

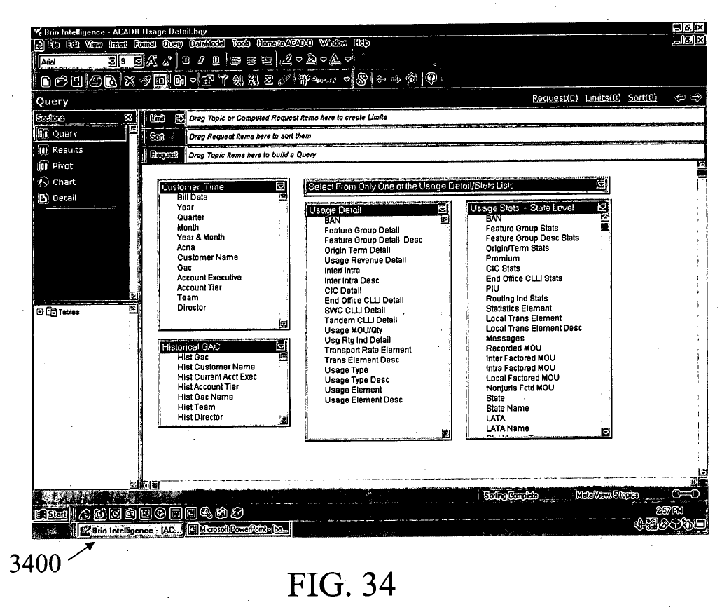

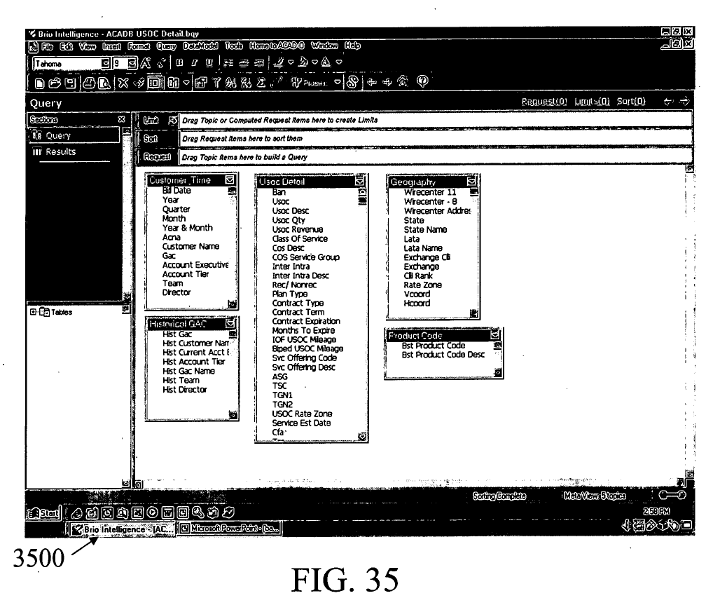

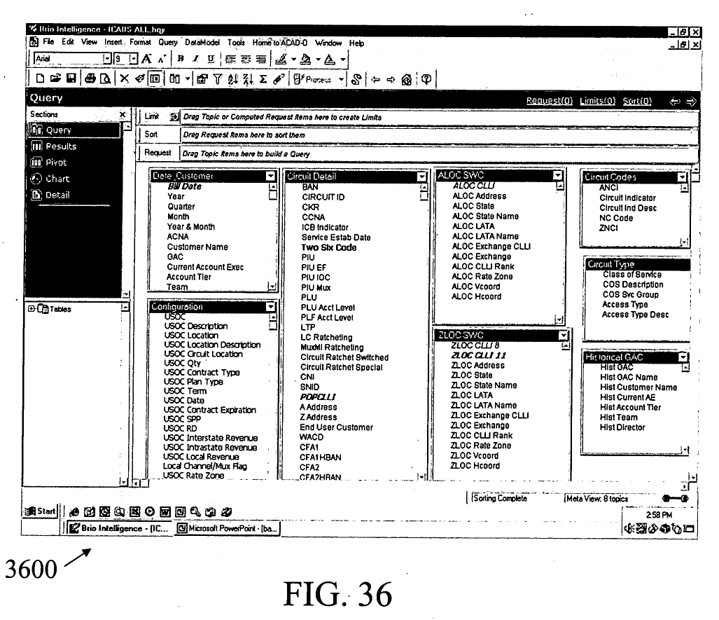

FIG. 32 provides a logical presentation of the ACAD-C Data Model. The ACAD-C data is sourced from the CABS Customer Service Record (CSR) file. The process of building the ACAD-C database includes the extraction of billing detail from the CABS CSR, transformation of the extracted data using business rules that will be described in following sections and merging the transformed data into one or more load files.

The process begins by reading merged CSR records from all RAOs for all the billing periods pulled by CABS for the previous week (or alternate time frame). This may be one or more bill periods. After these records are collected, they are stored and have not yet been changed from how they looked when created by CABS (on CSR backup output file MU40.BU1.PFA1005.MU4005GO(0)) and BDT backup file MU50.BU1.PFA5001.BDTFILE(0)). They have only been merged so that all RAO files for the bill periods for the week (or alternate time period) can appear on two files (one for CSR and one for BDT).

The CABS CSR data is read sequentially by bill period, ACNA, and CABS record sequence number. The following CSR record types are read: 400101 (Pack Header), 400505 (Account Identifier), 400510 (Bill Data FID), 401005 (Bill Name and Address), 401010 (Customer Service Address), 401505 (Left-Handed FID), 401510 (USOC Record), 401515 (Field Identifier (FID) Continuation record), 401517 (contract record), 401520 (USOC amounts), 401520-01 (USOC amounts suffix), 401521 (USOC amounts—mileage), 401521-01 (USOC amounts—mileage (suffix)), 409999 (Pack trailer).

CSR records 400505, 400510, 401005, and 401010 are processed to retrieve basic account information that will be used to build circuit records for the account. Specific circuit information is retrieved from Left-Hand FID record 401505. This information is stored while subsequent “circuit point” Left-Hand FID data as well as service and equipment (USOC) records that relate to the same circuit are read and stored. The USOC records consist of a 401510 and 401520 (USOC revenue and other amounts) (as well as 401520-01 suffix as necessary), and 401521 (and -01 suffix as appropriate) for USOC mileage records. Thereafter, the CSR records are processed by account and by section, one line item at a time as appropriate. Most data is retrieved from the Service and Equipment section of the account. All the above information is used to build a circuit record and related USOC records for the ACAD-C database. When a new circuit (or account) record is read from the CSR the current circuit and USOC records are written out.

The output data records (including FIDs, ratchet factors, etc.) from the ACAD-C database build are used primarily to build the ACAD-C database that focuses on circuit level data. Therefore the emphasis in the ACAD-C Data Model is building circuit records and related circuit configuration (USOC records), as well as other files that contain supporting circuit related data. The ACAD-C Data Model creates a circuit detail (CIRC) file, USOC (Circuit Configuration) (USOC) file, Two-Six Codes (TSC) file, A geography (AGEO) file, Z geography (ZGEO) file, POPCLLI (GEO) file, and an error (ERR) file as described in further detail below. Thereafter, these files are read and the CIRC and USOC files are edited and added to the error (ERR) file as appropriate. These files are then transmitted and loaded (except for the error file) to the ACAD-C database.

General Information—Business Rules Used in Sourcing ACAD-C Data

The records found on the CABS CSR file are a representation of the circuits as they are seen in the CSR section of BOCABS. Hence, reference is made to circuit FIDs (e.g., CLS, CLF, etc.) and to the locations on a circuit, or “points”, as indicated by FIDs Circuit Location (CKL) and Circuit Location Telephone Wire Center (CKLT). Behind these FIDs can be “floated” other FIDs delineated by a “/”. The general format, using a CLS circuit as an example, is as follows:

```
Account Level Info: /PIUM . . . /PIUD . . . /PIUE . . . /CCNA . . . LATA
ACTL [#]:
Circuit Detail: CLS 12.ABCD.123456 . . . SB . . . /PIU
        CKL 1-100 Main St./LSO . . . /ACTL . . . /SGN . . . /NCI . . . /NC . . . /CFA . . . /SN
                        USOC
                        USOC
                      CKL 2-115 East Ave./LSO . . . /NCI . . . /NC
                            USOC
```

Circuit Detail File

The circuit ID represents the circuit being billed and is found behind one of five circuit FIDs. The ID consists of alphas, numerics, and periods up to 45 characters in length. The one character circuit type identifies the circuit FID as follows:

| | |
|---|---|
| CLF - Common Language Facility Identification: | Circuit indicator = F |
| CLM - CLCI Message Trunk Identification: | Circuit indicator = M |
| CLS - Common Language Circuit Identification, | Circuit indicator = S |
| Serial Number: | |
| CLT - Common Language Circuit Identification, | Circuit indicator = T |
| TN Format: | |
| CLTB - CLCI Telephone Number Billing | Circuit indicator = B |

Two date fields are carried on the circuit record. The pack date on the record is pulled directly from the CSR Pack Header record on the CABS files. It is the date on which the CSR bill pack was created, in format CCYYMMDD. The bill date, also CCYYMMDD format, is the billing date of the account. The billing day or bill period is static, while the month and year change with the calendar date. CABS has ten bill periods in a month: 01, 04, 07, 10, 13, 16, 19, 22, 25, and 28. An account in the 28^{th} bill period of a particular month may or may not actually bill in that same month. Therefore, the pack date's month may differ from the bill date's month.

Certain information on a CABS account will apply to all of its circuits. The billing account number or BAN is a 13 character field formatted as follows:
NPA—3 char
Type of billing account—1 char
Bill period—2 char
Line number—4 char
Customer code—3 char
   Account numbers with the type of billing account field equal to “D” (DAL, or WATS) or “N” (special) are the only ones included in ACAD-C.

The Access Customer's Name Abbreviation or ACNA is a five character field assigned to a customer ordering access service. It is carried at the account level and applies to all circuits on that account, as does the Customer's Carrier Name Abbreviation or CCNA. These two fields may be the same.

Three percent of interstate usage (PIUs) are carried at the account level:
Percent of interstate usage for dedicated transport (PIUD)
Percent of interstate usage for entrance facility (PIUE)
Percent of interstate usage for multiplex (PIUM)
   The default for each of these fields is 999 and will always be defaulted on special access circuits. The PIU is used as part of the calculation of USOC revenue on switched access circuits. PLU (Percent Local Usage is also carried at the account level.

The majority of a circuit's detail is carried by the circuit level FIDs and applies only to that particular circuit. Initially, all of the ACAD accounts and the circuits on them are considered special access type because their account numbers contain an “N” in the 4^{th} position (the type of billing account position). The WATS accounts (“D”) will be also classified as special. However, circuits on “N” accounts may be re-classified as switched, or both special and switched, based on further information found at the circuit level. The primary reason an ‘N’ account might be classified as switched, or partially switched, is the presence of a RAF1 FID on the circuit. Also, an ‘N’ account circuit with an OH+++ class of service will initially be classified as switched.

Floated behind a circuit FID (i.e., CLS, CLF, CLM, CLT, and/or CLTB) are other CABS FIDs that provide information about the make-up of the circuit. The RAF1 FID (Rate Adjustment Factors for Digital (DS1) Services) is used to identify both a switched circuit on a special account and a circuit that has both special and switched billing (referred to as a “dual” circuit). The first number behind this FID is the number of channels available on that circuit. The second number is how many of those channels are switched. The following scenarios are, therefore, possible on “N” accounts that contain special access circuits:
1^{st} number=2^{nd} number→indicates there are X number of channels available and all of them are switched; therefore, all of the billing will be switched access on the circuit (e.g. RAF1 24, 24).
1^{st} number>2^{nd} number→indicates there are X number of channels available and some of them are switched (leaving others that are special); therefore, the circuit is classified as both switched and special access type and will be sent to the ACAD Red Brick database as two circuits—one special and one switched. (USOCs are identified as either special or switched based on a user provided table; these are associated with either the special, or switched classification of the circuit as appropriate). A RAF1 example for this situation is RAF1 672, 24.
2^{nd} number=0→indicates that none of the available channels are switched; therefore, the circuit remains classified as special access type (e.g. RAF1 24, 0)
   This example would be reversed if the circuit was classified as switched access based on the Basic Class of Service. The ACAD-C Data Model computes special and switched ratchet factors at circuit level based on “1^{st} number” and “2^{nd} number” above (fields RAT-SP and RAT-SW). The access type is carried as a “0” for special and a “1” for switched in the ACAD-C Data Model.

For most circuits, the bill date, access type, BAN, and circuit ID will combine to create a unique key identifying the circuit and the circuit sequence will be defaulted to zeroes. However, for SMARTRing circuits and multipoint circuits, this field must be used to obtain uniqueness.

On SMARTRing circuits, the pieces of the ring are broken up into two-point individual circuits, with the first point called the A location or ALOC and the second point labeled the Z location or ZLOC. The ZLOC of the first piece becomes the ALOC of the next piece and so on. Since these circuit pieces all have the same circuit id, the circuit sequence is incremented sequentially for each piece, thereby forcing uniqueness when combined with the other key fields.

Multipoint circuits are also broken down into two-piece individual circuits. The circuit ID is made unique by appending the SGN FID data to the end of the circuit ID. The SGN is found either at the CKL/CKLT level or at the USOC level. An example of a multipoint circuit is as follows:

CLS 67.XHGS.200180..GTES

```
CKL 1- . . . /LSO 334 299 /SGN 1/XR 2
    1 HTN
CKLT 2- DTHNALXA
    3 BCNDA
CKL 4- . . . /LSO 334 794 /SGN A/XR 2
    1 RJ48S
    1 T6ECS
CKL 5- . . . /LSO 334 793 /SGN B/XR 2
    1 RJ48S
    1 T6ECS
```

The pieces of the circuits would be:

| | | |
|---|---|---|
| 67.XHGS.200180 . . . GTES.1 | ALOC - CKL 1 | ZLOC - CKLT 2 |
| 67.XHGS.200180 . . . GTES.A | ALOC - CKLT 2 | ZLOC - CKL 4 |
| 67.XHGS.200180 . . . GTES.B | ALOC - CKLT 2 | ZLOC - CKL 5 |

As shown, CKLT locations act as hubs on multipoint circuits and will always be part of the two-point piece. The XR FID identifies the ALOC for a segment (Except for CKL1, in which case the XR identifies the ZLOC). The ZLOC is the location of the LSO floated after the CKL (except for CKL1 (in this case the CKL1 LSO location is the ALOC)).

In this example and most others, appending the SGN to the circuit ID does render uniqueness. However, other multipoint situations exist with either a point that does not have an SGN or has the SGN duplicated on the circuit, resulting in duplicate circuits IDs. To remedy this problem, the circuit sequence field, populated sequentially, is again utilized to provide uniqueness.

On “N” accounts, one of the USOCs will be marked as the basic class of service USOC. This information is used to identify circuits that need special handling, such as SMARTRing and local transport circuits. In addition, circuits with an MJB class of service also require special handling. MJB circuits contain only one location, a CKLT, which is treated like the ZLOC instead of the ALOC as would be expected.

Finally, WATS accounts do not carry a USOC that is marked as the basic class of service. However, the majority of the WATS circuits carry either an X2W or an X4W USOC, which will be used as the class of service USOC.

If a circuit carries one or more of the special assembly USOCs, the ICB indicator will be set to an “Y”. A list of these USOCs can be found in the CABS USOC manual; most start with “1ZZ”. If the circuit is not special assembly, the field defaults to an “N”.

The service establish date (SED) is carried at the circuit level and is re-formatted to CCYYMMDD.

The Percent of Interstate Usage (PIU FID) also applies at the circuit level for both switched and special circuits. Its default is 100.

Most of the CABS accounts carry ACTL information at the start of the account, consisting of one or more ACTL numbers and their associated POPCLLIs and POPCLLI addresses. The circuits themselves also carry an ACTL number that can be used to attempt a match back to the account level ACTLs to obtain the POPCLLI for the circuit. When there is a match, the ACTL POPCILLI is used to populate the POPCLLI for the circuit (even if the value consists of the CABS defaulted ‘Z’s). When there is no match, the POPCLLI value is defaulted to ‘NONE’.

The network code is a 4 character field populated from the circuit level FID NC.

If any of the USOCs on a circuit are under contract (indicated by FID/SPP or presence of CABS 401517 record associated with the USOC record), then the contract information will be carried at both the circuit level and the USOC level. Contract information consists of the contract type, the contract start/agreement date, the number of months of the contract or term, the expiration date, and the number of months until expiration. Since more than one contract can be found on a circuit, but the only one set of contract information can be carried at the circuit level, the contract information selected will be based on a hierarchy—any MSNS contract has precedence over a TPP contract which has precedence over a variable term contract, which has precedence over an SMAN contract. Circuits carrying more than one contract will have the multiple contracts indicator set to “Y”.
Contract Type: a one character field found behind the SPP (special pricing plan) FID; possible values are V=variable term contract, T=TPP contract, M=MSNS, or S=SMAN.
Contract Start Date: the date the contract started in CCYYMMDD format.
Contract Term: a two digit field representing the length of the contract in months.
Contract Expiration Date: the date the contract ends in CCYYMMDD format.
Months until Contract Expiration: the number of months between the current year/month and the ending year/month. This is a calculated field using the contract start date and the term.
Plan type: TPP and variable term contracts are assigned a plan type of A, B, or C based on the following matrix—
   If variable term contract
      If number of months (term) from 24 to 48, then plan type is A
      If number of months (term) from 49 to 72, then plan type is B
      If number of months (term) from 73 to 96, then plan type is C
   If TPP contract
      If number of months (term) from 12 to 36, then plan type is A
      If number of months (term) from 37 to 60, then plan type is B
      If number of months (term) from 61 to 96, then plan type is C

Circuits that have an HFND3 class of service will be populated with an “M” contract type even though the SPP FID is not present on these circuits. The other contract information will be picked up from the associated MSNS circuit; this association is made using the MCPA information which will be the same on the two circuits.

The points or locations on a circuit are represented by the FIDs CKL and CKLT. Various FIDs can be found behind CKLs, including an LSO FID, which is used in obtaining the CLLI code for the location. The LSO NPA and NXX and the account's LATA code are “looked up” on the CABS End Office (CEO) file where its associated CLLI code is extracted. If the LSO is not found on the CEO file, the LERG file is then searched. If a NPA/NXX/LATA combination is not found on the CEO/LERG, it is “looked up” again, this time excluding the LATA code. This 2^{nd} search is done because incorrect LATAs have been identified in CABS. If the NPA/NXX combination is found, this is considered a match and the LATA is changed on the ACAD record to match the CEO/LERG. If the NPA/NXX is still not found, the CLLI code becomes “NONE”.

CKLTs, while occasionally carrying some FID data, rarely have an LSO, but instead have the CLLI code present behind the CKLT.

The ALOC is the eight or eleven (8 or 11) character CLLI code of the serving wire center of the A location of the circuit. To obtain this CLLI, the A location LSO and account LATA code are “looked up” on the CEO/LERG. On most circuit types, the A location will be the first CKL encountered on the circuit; however, there are exceptions:
On a CLT circuit, the OCL CLLI code found behind the ASG FID acts as the ALOC.
If the LSO on the first CKL was not found on the CEO/LERG and “NONE” was populated in the ALOC field, the CKLT CLLI will be used as the ALOC.
If the first location on a CLT (that does not have an OCL FID), CLTB, or CLF circuit is a CKLT, it acts as the ALOC.
If the circuit has an MJB class of service, the first and only location is treated like the ZLOC and the circuit has no ALOC.
See rules above on handling ALOC for SMARTRing and multipoint circuits.
On a “normal” CABS circuit, the class of service USOC is found prior to the first point of the circuit and is used only to populate the class of service field. On a minority of the circuits, this class of service USOC carries an LSO FID and acts as the A location of that circuit. Any other USOCs encountered before the first CKL or CKLT are also considered to be under that location.

The CKLA or ALOC address is the address associated with the ALOC. It is pulled directly from the CKL FID.

The ANCI is the network channel interface (NCI) code that pertains to the A end of the circuit. It is pulled directly from the NCI FID found behind the appropriate CKL or CKLT.

The ZLOC is the eight or eleven (8 or 11) character CLLI code of the serving wire center of the Z location of the circuit. Its CLLI code is also retrieved from the LERG. On most circuit types, the Z location will be the last CKL or CKLT encountered on the circuit; however, there are exceptions:
If the circuit has an MJB class of service, the first and only location is treated like the ZLOC.
See rules above on handling ALOC for SMARTRing and multipoint circuits.

The CKLZ or ZLOC address is the address associated with the ZLOC. It is pulled directly from the CKL or CKLT FID.

The ZNCI is the network channel interface (NCI) code that pertains to the Z end of the circuit. It is pulled directly from the NCI FID found behind the appropriate CKL or CKLT.

The MUX is the location after the ALOC when there are subsequent locations, is not present on all circuit types, i.e., two point circuits would have an ALOC and a ZLOC, but no MUX. In most cases, the CKLT acts as the “middle” location and the CLLI code behind the FID will appear in the MUX field.

Interoffice miles equal the quantity of mileage USOCs encountered on the circuit. However, the BIPed IOF miles is calculated by multiplying the number of interoffice miles by the BIP and rounding the result. The Border Interconnection Percentage, or BIP, is a percentage representing the portion of mileage that is in BellSouth territory when the mileage also crosses into an Independent Company's territory. When both a BIP and a supplemental BIP are present on the USOC, the supplemental BIP is used in the calculation per CABS rules. According to the CABS documentation, a supplemental BIP “is used when local requirements mandate the use of a BIP other than the NECA FCC Tariff #4 BIP”. Both the BIP and the supplemental BIP are defaulted to 100%.

The local channel ratcheting factor (LC RAT) is a three (3) digit field representing the ratcheting factor for the local channel USOC of a circuit. The MUXMI ratcheting is a three (3) digit field representing the ratcheting factor for mileage and other USOCs on a circuit. The default for both fields is 100%. An indicator is set on the USOC record if ratcheting is present and the rules for USOC-RAT condensed in Table 1 below are then followed for determining the ratchet factor.

TABLE 1
Ratchet Factors

| | | | | | Local | |
|---|---|---|---|---|---|---|
| Access | ASG | Class of | | Ratchet | Channel | MUXMI |
| Type | Data | Service | USOC | Calculation | Ratchet | Ratchet |
| Special | any | XDH6X | TMJ3A | (1 − ((1 − RAF on | | X |
| | | | | USOC) * 0.5)) | | |
| | | | TMJ3C | (1 − ((1 − RAF on | | X |
| | | | | USOC) * 0.5)) | | |
| | | | TMJ3B | (1 − ((1 − RAF on | | X |
| | | | | USOC) * 0.5)) | | |
| | | | SPF3C | (1 − ((1 − RAF on | | X |
| | | | | USOC) * 0.5)) | | |
| | | | SPA3A | (1 − ((1 − RAF on | | X |
| | | | | USOC) * 05)) | | |
| Special | any | XDH6X | TMJ1A | (1 − ((1 − RAF on | | X |
| | | | | USOC) * 0.5)) | | |
| | | | TMJ1B | (1 − ((1 − RAF on | | X |
| | | | | USOC) * 0.5)) | | |
| | | | TMJ1C | (1 − ((1 − RAF on | | X |
| | | | | USOC) * 0.5)) | | |
| | | | MQ1++ | (1 − ((1 − RAF on | | X |
| | | | | USOC) * 0.5)) | | |
| Special | 3^{rd} char = “3” | Any | not | none | | X |
| | | | HFRO3 | | | |
| | | | not | none | | X |
| | | | HFR12 | | | |
| | | | not | none | | X |
| | | | HFR48 | | | |
| | | | not | none | | X |
| | | | HFRCC | | | |
| | | | not | none | | X |
| | | | HFRST | | | |
| Special | any | Any | TPB1X | none | | |
| | | | TPB2X | none | | |
| | | | TPB1A | none | | |
| | | | TPB2A | none | | |
| | | | TPBSC | none | | |
| | | | TMECS | none | X | |
| | | | 1XCDX | none | | |
| | | | TMEAC | none | | |
| | | | CND3X | none | X | |
| | | | CNC1X | none | X | |
| | | | BMAOX | none | | |
| | | | BMAXX | none | | |
| | | | BM3OX | none | | |
| | | | BM3XX | none | | |
| | | | TMELC | none | | |
| | | | 1L5++ | none | | |
| | | | MQ1++ | none | | |
| | | | MQ3++ | none | | |
| | | | PC4++ | none | | |
| | | | QMU++ | none | | |
| | | | QP1++ | none | | |
| | | | SHN++ | none | | |
| | | | 1HA++ | none | X | |
| | | | 1HV++ | none | X | |
| | | | 1HX++ | none | | |
| | | | HFN++ | none | | |
| | | | HFS++ | none | X | |
| | | | 1PQ++ | none | | |
| | | | 1LP++ | none | | |
| Switched | any | Any | TEFHG | none | X | |
| | | | TEFHJ | none | X | |
| | | | SATCO | none | | |
| | | | CNDS1 | none | X | |
| | | | CNDS3 | none | X | |
| | | | TEFC3 | none | | |
| | | | TEFC1 | none | X | |
| | | | 1L5XL | none | | X (mileage) |
| | | | 1L5XM | none | | X (mileage) |
| | | | SATC1 | none | | X (mileage) |
| | | | SATCS | none | | X (mileage) |

Interstate revenue, intrastate revenue, and local revenue are pulled directly from the USOC record. There are also fields available for the intralata interstate and intrastate revenues; currently these revenues are not applicable. All the above revenue fields are then combined to provide the total revenue for each circuit.

Special revenue and switched revenue combine to equal the total revenue for the circuit.

EC Revenues (Interstate, Intrastate, Local, Intralata Exchange Company revenues) consists of non-BST revenue. For the most part, except for these fields, non-BST revenues/equipment are not reflected in ACAD. The determination of non-BST v/v BST is based on the State Level Company Code sourced from CABS (where BST=company codes 5181-5184 and 5191-5194).

The SNID, or SONET Network Identifier, is a circuit level FID carrying 6 to 46 characters of data. If a 5 character SNID is found (that was allowed with older data), an “N” will be appended to the front. These 5 character SNIDs will also be identified as an error.

The Customer Network Identification, or CNI, is also a circuit level FID carrying 14 characters of data. It is often found on LightGate classes of service. If the class of service of the CNI's circuit is HFQC6, the 4^{th} character of the CNI becomes the DS3 Point to Point System Size. Otherwise, if a HFSC6 or HFSC7 USOC is found on a circuit, the DS3 Point to Point System Size is set to ‘1’. On all other circuits, the one character system size will be a space.

If a circuit's ANCI or ZNCI contains “QB”, the colocation field is set to “Y”; otherwise, this field defaults to “N”. (If the “QB” was found on an ANCI or ZNCI on a circuit with an XDH3X class of service, an error message is generated as it is invalid for this situation to occur on this class of service.) If the colocation field is set to a “Y” on a circuit with an HFQC6 class of service, the DS3 Point to Point System Size is then set to “C”.

The Ringsize is a two digit field representing the SMARTRing ringsize. It is pulled from the last two characters of an “XDE++” class of service circuit.

The Local Transport (LTP) FID is another circuit level FID carried in ACAD for switched access circuits only. Its 1 to 4 characters of data is pulled directly from the FID.

The ACAD end user customer field is populated from the SN (Service Name) FID carried at the CKL level. It can have up to 30 characters of data.

The WACD is defined as the Work Authorization Circuit Detail and can be up to 150 characters in CABS. Only the first 47 characters are picked up from the data behind this CKL level FID and then populated in ACAD.

The Connection Facility Assignments on a circuit, or CFA1 and CFA2, are found behind the CKL and CKLT FIDs. If the CFA is found on the 1^{st} CKL or CKLT, 42 characters of data are then populated in the CFA1 field. Any other CFA FID data found is populated in CFA2. ( The last CFA floated FID is used for CFA2). In addition, if there are any intermediate CFAs they will be populated in the ICF1-ICF4 fields from the corresponding FID.

In order to isolate the slot and ID portions of both the CFAs above, fields CFA1ID and CFA2ID show the corresponding CFA IDs, and CFA1SLOT and CFA2SLOT show corresponding CFA slots.

The ZNHC (Not High Capacity Billing) FID values are processed by the ACAD Data Model as ZNHC1 and ZNHC2. ZNHC1 is any ZNHC value following the first CFA (on a CKL) and ZNHC2 is the ZNHC following any 2^{nd} CFA after the CKL.

The same rule for ZNHC also applies to HBAN (CFA1HBAN and CFA2HBAN). (HBAN is High Capacity Billing Account Number). The first of these values is for the HBAN following the first CFA, the second value for that HBAN following the 2^{nd} CFA.

The customer's assigned circuit reference, or CKR, is carried at the circuit level and can be up to 45 characters in length in no specific format.

USOC File

CABS circuits carry revenue and non-revenue generating USOCs. Following are rules that are used in the extraction process:
The non-revenue carrying UDP USOCs are ignored.
As mentioned in the “Circuit” section of this document, one USOC will usually be found that carries the class of service indicator. It is not carried under a circuit location and sometimes serves as the A location.
Each USOC is examined against the Special Assembly USOC list to determine if the special assembly indicator should be set to “S” (see Appendix E).
If the SPP FID is found behind the USOC, contract information will be gleaned from its contents. Only USOCs with a special access type can be under contract. Switched USOCs under contract will cause an error record to be created.
On multipoint circuits, the SGN FID is sometimes populated on the USOC only and not at the CKL or CKLT level.
Bridging USOCs (BCN++), found on multipoint circuits, will be split between the various pieces of the multipoint circuit, i.e., one bridging USOC will be places on each piece assuming the quantity of bridging allows this. Any “extra” bridges will be put on the last piece of the circuit.
If a USOC is present on a circuit identified as dual (both switched and special), a table is used to determine if the USOC and its revenue is switched or special. The switched or special designation is based on the USOC definition.
Like USOCs will be combined and their quantities and revenues totaled.
Mileage USOCs with a zero quantity will be ignored.
If a USOC is found on the local channel list, the local channel flag will be set.

Each USOC carries a USOC location with possible values of A, Z, M, F, or P. A value of “A” means the USOC was found under the first location or point of the circuit. Likewise, an “M” value means the USOC is located at the MUX location and a “Z” value means the USOC is under the Z location. All “A” USOCs should have a corresponding ALOC, all “M” USOCs should have a MUX, and all “Z” USOCs should have a ZLOC.

The interstate and intrastate revenues on a mileage USOC are divided into the fixed portion and the per mile portion, hence the “F” and “P” records. The calculation for the fixed and per mile revenues are:
Fixed revenue=Ratchet Factor*(PIU*(Flat Rate*BIP))
Per mile revenue=Ratchet Factor*(PIU*(Unit Rate*Quantity*BIP))
   (For local revenue, the computation is as above, except that PLU (Percent Local Usage), is applied as a factor instead of PIU).

Revenue for other USOCs is sourced directly from the CABS record, as is the quantity for all USOCs.

For edit purposes, billed revenues are recomputed based on CABS values and compared to the billed revenues (above) as sourced from CABS. Error records are created when discrepancies exist. The recomputed values do not appear on the ACAD data base—they are used for edit purposes only.

The contract start date and contract term that is carried at the circuit level is also carried at the USOC level, as appropriate.

Several USOC FIDs are populated as they are provided by CABS, and as one of ordinary skill in the art appreciates, these FIDS are self explanatory.

Several USOC fields are populated with Flexible Pricing related values:
USOC-CLLI is the CLLI for the CKL/CKLT under which the USOC is located.
USOC-MSA is the MSA value associated with the USOC. For a non-mileage USOC, this is the MSA associated with the ALOC (A Location) for the circuit on which the USOC resides. For a mileage USOC, this is the MSA associated with the ZLOC. The MSA is determined by matching the location CLLI (ALOC or ZLOC) to a user maintained CLLI/MSA table.
USOC-MSAI 1 and USOC-MSAI2 are the MSA associated with USOC's circuit ALOC, and ZLOC, respectively, as sourced from CABS MSAI FID on the USOC.
The USOC Flexible Pricing Indicator (USOC-FP-Disc) is computed by ACAD. If a non-interoffice USOC is a qualifying flexible pricing USOC (i.e., it appears (based on the class of service for the circuit) on the user maintained FlexP USOC table as a qualifying USOC), and if it resides on a circuit that has an ALOC qualifying MSA (i.e if the MSA as computed above is a qualifying MSA as indicated by the user-maintained MSA table), then the flexible pricing indicator is set to ‘Y. For an interoffice mileage USOC, the above is also true, except that both ALOC and ZLOC MSAs must be eligible based on the CLLI/MSA table for the discount indicator to be set to ‘Y’.
USOC-RLFSI is the FlexP indicator as sourced from CABS FID RLFS.
USOC-FP-RATE-CAT is the rate category of the USOC as indicated by the FlexP USOC table.
   TSC File

The two-six code (TSC), an eight (8) character field, is pulled from the TSC FID which is found either at the circuit level or behind the UDP USOC(s). One circuit may carry multiple two-six codes and all will be found in ACAD.

POPCLLIs (Geography) File

The POPCLLIs (Geography) are records based on the POPCLLIs set in DC08J10 when the List section ACTL number matches the ACTL number at the circuit level.

A Geography File

The A geography is based on the NPA and NXX of the LSO that is looked up on the CEO/LERG in order to obtain the associated V&H coordinates, addresses, etc.

Z Geography File

And, the Z geography is based on the NPA and NXX of the LSO is looked up on the CEO/LERG in order to obtain the associated V&H coordinates, addresses, etc.

ACAD-B Database

Unlike the ACAD-C Data Model described above, the ACAD-B Data Model processes all accounts it receives from CABS to build a comprehensive ACAD-B database. The ACAD-B data is sourced from the CABS CSR and also the CABS BDT. The process of building the ACAD-C database includes the extraction of billing detail from the CABS CSR and BDT, transformation of the extracted data using business rules that will be described in following sections, and merging the transformed data into one or more load files.

The process begins by reading merged CSR and BDT records from all the CABS RAOs for all the billing periods pulled by CABS for the previous week (or alternate time frame). This is usually two or three bill periods. After these records are collected, they are stored and have not yet been changed from how they looked when created by CABS (on CSR backup output file MU40.BU1.PFA1005.MU4005GO(0)) and BDT backup file MU50.BU1.PFA5001.BDTFILE(0)). They have only been merged so that all RAOs for the bill periods for the week (or alternate time period) can appear on two files (one for CSR and one for BDT).

Next, the CABS CSR data is read sequentially by bill period, ACNA, and CABS record sequence number. In addition, the following CSR record types are read: 400101 (Pack Header), 400505 (Account Identifier), 400510 (Bill Data FID), 401005 (Bill Name and Address), 401010 (Customer Service Address), 401505 (Left-Handed FID), 401510 (USOC Record), 401515 (FID Continuation record), 401517 (contract record), 401520 (USOC amounts), 401520-01 (USOC amounts suffix), 401521 (USOC amounts—mileage), 401521-01 (USOC amounts—mileage (suffix)), 409999 (Pack trailer). Then, the CABS BDT data is sequentially by bill period, ACNA, and CABS record sequence number. The following BDT record types are also read: 100101 (Pack Header), 100505-01 (Bill Face Heading Suffix), 100510 (Balance Due Amounts), 100512 (Detail of Current Charges 1), 100513 (Detail of Current Charges 2), 100513-01 (Detail of Current Charges Suffix), 100550 (Detail of Current Charges 1 by State), 100551 (Detail of Current Charges 2 by State), 102005 (Detail of Adjustments), 102005-01 (Detail of Adjustments Suffix record), 102005-02 (Detail of Adjustments Suffix record), 103010 (OC&C Heading), 103015 (OC&C Phrase Code data), 103015-01, 103015-01 (OC&C Phrase Code data suffix), 103020 (OC&C USOC data), 103505 (Local Transport Usage Detail), 103505-01 (Local Transport Usage Detail suffix, 103510 (end office usage detail), 103515 (carrier common line usage detail), 103520 (miscellaneous usage detail), 103520-01 (miscellaneous usage detail suffix), 10350J (usage stats detail), 10350J-01 (usage stats detail suffix), 103710 (CMRS usage detail—end office), 103720 (CMRS usage detail—miscellaneous), 103720-01 (CMRS usage detail—miscellaneous suffix), 103727 (CMRS usage detail—statistics), 104510 (interstate billing and collection messages), 104555 (intrastate billing and collection messages), 104530 (billing and collection interstate totals), 104575 (intrastate billing and collection totals), 104590 (billing and collection summary charges).

Thereafter, the CSR records are processed by account and by section, one line item at a time as appropriate. Most data is retrieved from the Service and Equipment section of the account. The processing of the CSR data in ACAD-B Data Model is based on the same processes used in the ACAD-C Data Model described above; however, the ACAD-B processing is much less complex and the primary output from the CSR process is the ACAD-B USOC file.

The ACAD-B Data Model also processes the BDT (billing) records by account, sequentially, by line item on the bill (one BDT record, generally speaking, represents one line item on the bill). The billing records are used primarily to build a database that focuses on billing level data. Because of this, the processing of BDT data in ACAD-B is largely a matter of reading in many buckets of BDT data directly from CABS. While one to one data transformation is common, complex data manipulation and/or business rules are rare in ACAD-B. Basically, this data is read, summarized, stored, and presented in such a way that it can be useful to the ACAD-B data warehouse users.

A summary of the CABS data processed by the ACAD-B Data Model include:
Account information such as ACNA, BAN, etc.
Billing name and address.
Total adjustment revenue—interstate, intrastate, local, etc.
Total interstate, intrastate, local access charges.
Late payment charges.
OC&C, usage, (interstate, intrastate, local) billing revenues.
All of the above, at state level.
Adjustments.
OC&C detail, USOC or not USOC related.
Usage revenues and quantity for local transport, end office, and carrier common line.
Usage statistics, basically factored MOU—interstate, intrastate, local, non-jurisdictional.
Billing and collection, basically interstate and intrastate message quantities, also Category (CAT) 41 and CAT 42 interstate and intrastate messages and revenues.
   The ACAD-B billing summary file (BANSUMM) contains billing summary records by state file (STATSUMM), USOC file (USOC), geography file (GEO), CPNI file (CPNI), miscellaneous billing file (MISC), usage statistics file (STAT), usage file (USG). Wirecenter file (WCTR), BNA (Billing Name and Address) file (BNA), and an error (ERR) file. Thereafter, product code/service offering information is assigned to the USOC and MISC files above after a lookup of the MAREVS database that stores revenue categorized by product for regulatory accounting and for product tracking. Next, the above files are read, edited, and information is added to the error (ERR) file as appropriate. These files are then transmitted and loaded (except for the error file) to the ACAD-B database.
   MABS

The MABS models are based on the representation of the billing CSR records. For each credit given, the customer, the BAN, and the amount of the credit can be queried, in addition to other information. Details that may be generated include an SLA for Frame Relay detail, an SP FLEXP revenue summary detail, an SW FLEXP usage detail, and an SW FLEXP USOC detail.

SIW

The Strategic Information Warehouse (SIW) includes the Integrated Customer Database (ICD). This database contains account, address, billing, USOC and working line service/product information from CRIS for the local service of residential and business customers. From these tables, various data models have been created for each type of customer including: Business, Competitive Local Exchange Carrier Business Master (CLEC Bus Master), CLEC Business, Competitive Local Exchange Carrier Residential Master (CLEC Res Master), CLEC Residence, and wireless.

ACAD MABS ADMIN

The access carrier service customer rate and billing information in MABS administration 440 is only accessible by a select group of users in additional processing for creating customer billing credits. This information include: (1) an Audit Ad Hoc FSP administrative section that provides holding FSP credits that were sent to CABS for the customer bill, (2) an Audit Ad Hoc TSP administrative section that details holding TSP credits that were sent to CABS for the customer bill, (3) an Audit Summary Report administrative section that produces a summary audit report of the FSP and TSP credits sent to CABS for the customer bill, (4) a MABS ADMIN Contracts administrative section that allows authorized users to administer FSP and TSP contracts (that is the users can add, delete, and update contracts, and produce reports of the contract information), (5) a COS Groups administrative section that allows authorized users to assign class of service groups to existing class of service USOCs, (5) a Managed Shared Network Service Access Carrier Termination Location (MSNS ACTLs) detail that allows authorized users to administer the MSNS ACTL table by: adding new GACs, adding new ACTLs to existing GACs, and deleting ACTLs from existing GACs, (6) an MSNS Adjustments administrative section that allows authorized users to administer the TSP MSNS Adjustments table by: adding new adjustments, updating adjustments, and/or deleting adjustments, (7) an SP FLEXP MSAs administrative section that allows authorized users to administer the Flexible Pricing Special Access MSA CLLIs by adding and deleting CLLIs to existing MSAs and generating additional reports of all CLLIs and CLLI history, (8) an Upload SLA Data administrative section that allows authorized users to upload an MS EXCEL™ spreadsheet with SLA credit percentages by ACNA, Phone Number, and Circuit, and after the records are edited, the circuit's total interstate revenue is retrieved, stored, and used in an Multiple Virtual Storage (MVS) process to create and send SLA credits to CABS to apply to the customers' bills, and (9) a USOCs administrative section that allows authorized users to administer the USOCs table by adding, updating, and deleting the USOCs by plan type.

While the methods and systems described herein and illustrated in the figures contain many specific systems and methods for selected carrier access customer service rate and billing detail, these systems and methods should not be construed as limitations on the scope of the invention, but rather each is an example of an embodiment. For example, the above figures of exemplary GUIs include display screens, toolbar menus, and tab menus that illustrate systems and methods for executing exemplary carrier access service customer rate and billing detail via ACAD Online 316. As would be apparent to one of ordinary skill in the art, many other variations on the systems and methods are possible, including differently grouped and ordered systems and method steps. Accordingly, the scope of the invention should be determined not by the embodiments illustrated, but by the appended claims and their equivalents.

1. A method comprising the steps of:
accessing a billing record of the customer from a carrier access billing system, wherein the billing record is accessed from the multiple customer operations units and the multiple revenue accounting offices, and wherein the carrier access billing system maintains billing records for wholesale customers that purchase blocks of telephone capacity, and
compiling the billing record to create a merged billing record; and
processing the merged billing record to create an access customer analysis database comprising data associated with at least one of a customer, a service agreement, a service usage, a service rate, service availability, a type of service, and a service region.

2. The method of claim 1, further comprising the steps of:
accessing the access customer analysis database; and
creating an access carrier service rate and billing detail based on the merged billing record, the access carrier service rate and billing detail comprising data associated with at least one of a customer, a service agreement, a service usage, a service rate, service availability, a type of service, and a service region, wherein the access carrier service rate and billing detail provides at least one of a administrative report, a sales proposal, a customer billing dispute resolution report, a product analysis and development tool, an update to a discount plan, an input of a billing adjustment, a modification to billing data, and a modification to rate data.

3. The method of claim 2, wherein step of creating the access carrier service rate and billing detail comprises presenting an interactive graphical user interface for selecting at least one of a group of accounts under one access carrier customer, a relation between a plurality of access carrier customers, and a unique access carrier customer-based information.

4. The method of claim 2, wherein step of creating the access carrier service rate and billing detail comprises presenting an interactive graphical user interface for selecting at least one of a customer identifier, a service agreement, a service usage, a service rate, service availability, a type of service, and a service region.

5. The method of claim 2, wherein step of creating the access carrier service rate and billing detail comprises presenting an interactive graphical user interface for associating at least one of a customer identifier, a service agreement, a service usage, a service rate, service availability, a type of service, and a service region.

6. The method of claim 2, further comprising the steps of:
reporting the access carrier service rate and billing detail of the customer.

7. The method of claim 2, further comprising the step of:
using the access carrier service rate and billing detail to manage an access carrier rate and billing plan.

8. The method of claim 7, further comprising the step of:
displaying at least one of alternate promotional codes, rate plans, and service agreements.

9. The method of claim 8, wherein the step of displaying at least one of alternate promotional codes, rate plans, and service agreements further comprises the steps of:
retrieving, from the access customer analysis database, data relevant to terms and conditions of the access carrier service rate and billing detail;
calculating a discount based on the data relevant to the terms and conditions;
creating an other-charge-and-credit based on the discount; and
passing the other-charge-and-credit to the carrier access billing system for inclusion on the access carrier rate and billing plan.

10. The method of claim 1, further comprising the steps of:
accessing a regional rate record of a customer from a local exchange routing guide information system, wherein the regional rate record is accessed from multiple customer operations units and multiple revenue accounting offices, and wherein the local exchange routing guide information system maintains routing and rate records for terminating a telephone call to an appropriate telephone number at a proper rate,
compiling at least one of the regional rate record and the billing record to create a merged rate and billing record;
processing the merged rate and billing record to create the access customer analysis database;
accessing the access customer analysis database;
creating the access carrier service rate and billing detail based on the merged billing record;
retrieving, from the access customer analysis database, data relevant to terms and conditions of the access carrier service rate and billing detail;
calculating a discount based on the data relevant to the terms and conditions;
creating an other-charge-and-credit based on the discount; and
passing the other-charge-and-credit to at least one of the local exchange routing guide information system and the carrier access billing system for inclusion on the access carrier rate and billing plan.

11. A system comprising:
a carrier access billing system, wherein the carrier access billing system maintains billing records for wholesale customers that purchase blocks of telephone capacity;
a local exchange routing guide information system, wherein the local exchange routing guide information system maintains routing and rate records for terminating a telephone call to an appropriate telephone number at a proper rate;
a data model for building an access customer analysis database that
interfaces with the carrier access billing system and the local exchange routing guide,
accesses a billing record of the customer from the carrier access billing system, wherein the billing record is accessed from the multiple customer operations units and the multiple revenue accounting offices,
uses business rules to automatically compile the billing record to create a merged rate and billing record, the merged rate and billing record associated with at least one of a customer identifier, a service agreement, a service usage, a service rate, service availability, a type of service, and a service region,
creates and maintains an access carrier analysis database of the merged rate and billing record,
interfaces with an access carrier service rate and billing details management application, and
supports online tasks and offline data maintenance and exchange.

12. The system of claim 11, wherein the access carrier service rate and billing details management application:
creates and maintains a selected view associated with one or more compiled rate and billing records, the selected view comprising compiled rate and billing records associated with at least one of a customer, a service agreement, a service usage, a service rate, service availability, a type of service, and a service region, and
provides means to establish, monitor, take action on, and report on a customer term and condition of the compiled rate and billing record.

13. The system of claim 11, wherein the access carrier service rate and billing details management application comprises an online portion having a graphical user interface, an application server, and a database server.

14. The system of claim 11, wherein the access carrier service rate and billing details management application comprises an online portion having a graphical user interface and a database server.

15. The system of claim 11, wherein the graphical user interface is displayed on a client workstation.

16. The system of claim 15, wherein the client workstation comprises at least one of the following:
a wireless communications device,
a mobile phone,
a cellular phone,
a WAP phone,
a satellite phone
a computer,
a modem,
a pager,
a digital music device,
a digital recording device,
a personal digital assistant,
an interactive television,
a digital signal processor, and
a Global Positioning System device.

17. The system of claim 13, wherein the application server resides on a UNIX-based system.

18. The system of claim 13, wherein the database resides on a UNIX-based system.

19. The system of claim 13, wherein the application server resides on a WINDOWS®-based system.

20. The system of claim 13, wherein the database resides on a WINDOWS®-based system.

21. A system comprising:
an application server containing an application server program; and
a database server containing an access customer analysis database,
wherein in response to a request from a client system for an access carrier service rate and billing detail, the application server program retrieves information from the access customer analysis database, the application server program performs any required business logic, the application server program returns the information to the client system,
wherein the application server contains business applications and legacy applications,
wherein the business applications comprise an access carrier service rate and billing details manager application, and wherein the legacy applications comprise a local exchange routing guide and a carrier access billing system,
wherein the carrier access billing system maintains billing records for wholesale customers that purchase blocks of telephone capacity, and
wherein the information retrieved from the access customer analysis database comprises at least one of
a billing record from the carrier access billing system,
network configuration detail from the local exchange routing guide, and
a merged regional rate record and billing record, the merged regional rate and billing record compiled using a data model of business rules.

22. A system comprising:
a client system containing a client program; and
a database server containing an access customer analysis database,
wherein in response to a user request for an access carrier service rate and billing detail, the client program retrieves selected information from the database, the client program performs any required business logic, and the client program formats and displays the access carrier service rate and billing details on a screen for the user,
wherein the client program comprises an access carrier service rate and billing details manager application, and wherein the legacy applications comprise a local exchange routing guide and a carrier access billing system,
wherein the carrier access billing system maintains billing records for wholesale customers that purchase blocks of telephone capacity, and
wherein the information retrieved from the access customer analysis database comprises at least one of
a billing record from the carrier access billing system,
network configuration detail from the local exchange routing guide, and
a merged regional rate record and billing record, the merged regional rate and billing record compiled using a data model of business rules.
